(19) United States
(12) Patent Application Publication
(10) Pub. No.: US 2017/0165511 A1
(43) Pub. Date: Jun. 15, 2017

(54) FIRE PROTECTION SYSTEMS AND METHODS FOR ATTIC/COMBUSTIBLE CONCEALED SPACES BENEATH PITCHED ROOFS USING PREACTION SPRINKLER VALVE ASSEMBLIES AND RELATED DRY SPRINKLER DEVICES

(71) Applicant: Globe Fire Sprinkler Corporation, Standish, MI (US)

(72) Inventors: Stephen J. MEYER, Chester Springs, PA (US); Yoram RINGER, Providence, RI (US); Thomas Edwin ARCHIBALD, Midland, MI (US); Kevin Desmond MAUGHAN, North Kingstown, RI (US)

(21) Appl. No.: 15/380,605

(22) Filed: Dec. 15, 2016

Related U.S. Application Data
(63) Continuation-in-part of application No. 15/222,770, filed on Jul. 28, 2016.
(60) Provisional application No. 62/344,463, filed on Jun. 2, 2016.
(60) Provisional application No. 62/304,585, filed on Mar. 7, 2016.
(60) Provisional application No. 62/267,445, filed on Dec. 15, 2015.

(51) Int. Cl. A62C 3/02; A62C 35/68; A62C 37/48; A62C 35/60

(52) U.S. Cl. CPC A62C 3/0214; A62C 35/60; A62C 35/68; A62C 37/48

(57) ABSTRACT

A sprinkler system protects a combustible concealed space between a floor and a sloped roof above and includes a water supply line connected with a valve having a body and a passageway connecting an inlet and an outlet. A seal member is located and supported in a body along the passageway to block and open the passageway. A water discharge device is connected by piping with the outlet and installed in the concealed space at a location remote from the valve to spray water onto the Boon A thermal activation component includes a thermally responsive element installed at a location in the concealed space remote from the valve and the water discharge device. A flexible connector mechanically connects the thermal activation component and the valve and initiates movement of the seal member in response to a physical change in the thermally responsive element due to heating thereof.

### CROSS-REFERENCE TO RELATED APPLICATIONS

This application is a continuation-in-part of U.S. patent application Ser. No. 15/222,770 filed Jul. 28, 2016 and claims the benefit of priority under 35 USC §119(e) of U.S. Provisional Patent Applications No. 62/344,463 filed Jun. 2, 2016, Ser. No. 62/304,585 tiled Mar. 7, 2016, and Ser. No. 62/267,445 filed Dec. 15, 2015; the contents of all of these applications are incorporated herein by reference in their entirety.

### BACKGROUND OF THE INVENTION

The present invention relates generally to fire protection, and, more particularly, to fire protection systems for use in attics and combustible concealed spaces beneath pitched roofs.

Fire sprinkler systems, and the installation and operation thereof, are subject to nationally recognized codes and standards, such as NEPA 13, 13D and 13R, which are incorporated by reference herein. Furthermore, NFPA 13 and other standards require the use of equipment and components that have been independently tested by a recognized laboratory (e.g. UL or FM) to identify and verify their physical characteristics and performance.

A particular problem arises with respect to the provision of fire protection in attics of buildings where the roof structures are pitched and are constructed of wooden joists and rafters or wooden trusses. This is the normally unoccupied space between the horizontal ceiling in the uppermost floor of an occupied building and the pitched roof thereof.

Prior to the mid 1990s, NFPA 13 allowed the use of standard spray (½″ orifice/5.6 K factor) sprinklers in attics of wooden construction in accordance with their normal listings for coverage areas (130 square feet) with a delivered water density of 0.1 gallons per minute (GPM) per square foot of coverage area. At that time UL subjected NFPA 13-allowed installations of standard spray sprinklers to fire tests simulating a wood construction attic. There were several test fires. At least one test fire grew so quickly before the standard spray sprinklers activated that, by the time the sprinklers activated, the fire was out of control and the test structure was completely consumed.

In response, and having no better option, NFPA continued to allow the use of standard spray sprinklers but (1) restricted their spacing to provide coverage areas of only 130 square feet per sprinkler and (2) imposed a hydraulic demand penalty (a required added volume of water to be deliverable to a set number of sprinklers) of thirty percent even while retaining the light hazard, delivered water density requirement of 0.1 GPM/sq. ft. An additional hydraulic demand penalty of thirty percent was imposed on dry sprinkler systems. None of the penalties addressed the real problem of delayed activation of standard spray sprinklers in an attic environment, but the penalties did at least assure a flood of delivered water once the sprinklers are activated.

A co-inventor on this application was co-inventor of a collection of “Special Application” sprinklers, designed specifically for attics, which passed UL fire tests. As a consequence, such sprinklers were not subject to restricted coverage areas or hydraulic demand penalties imposed on standard spray sprinklers. So-called “back to back” and “single direction” Special Application attic sprinklers were allowed to be installed to provide the maximum demonstrated effective coverage areas, up to 400 square feet per sprinkler. Consequently, the Special Application sprinklers have dominated the market for attic fire sprinkler protection in wood construction for the past twenty years.

As good as the Special Application sprinklers were, they stilt had drawbacks. All were uprights in order to be located as close to the peak of a pitched roof as the water spray patterns would permit, in order to expose the thermally responsive elements (alcohol-filled glass bulbs or fusible link assemblies) to the heat of a fire to activate the sprinkler(s) most quickly. Even so, for root pitches with a rise of 4 over a run of 12 (“4/12”) and above (up to 12/12), a back to back and single direction sprinkler had to be installed with the deflector no closer than sixteen inches and no farther than twenty-two inches below the bottom surface of the peak or ridge of the roof. The deflectors further had to be oriented parallel the framing (trusses and joists). Moreover, a back to back or single direction sprinkler had to be installed with a deflector selected to conform to the pitch of the roof under which the sprinkler was installed, whereas the present invention allows a sprinkler with any standard deflector to be installed under roofs of any pitch. While UL permitted such sprinklers to provide up to 400 square feet of coverage area protection (the maximum coverage area per sprinkler permitted by UL for any light hazard sprinkler protection), the sprinklers had to be spaced no more than six feet apart from one another along the roof peak to assure adequate response times; and the sprinkles could be no closer than four feet from one another due to concerns of potential wetting (“cold solder”) of adjoining sprinklers hindering or preventing their activation. This resulted in very short (four to six foot) spacing along the roof peak but very wide eave to cave protection areas (up to sixty feet across for a back to back and forty feet for a single direction). If there were obstructions (e.g. cross beams, trusses, etc.) extending into the throw pattern, protection had to be provided by standard spray or another type of special application sprinkler having a more restricted maximum coverage area of ten by twelve feet. Even though patent protection on back to back and single direction special application attic sprinklers has expired, such sprinklers have been able to maintain a relatively high price that reflects the cost savings from their use compared with the cost of providing comparable protection with standard spray sprinklers.

It would be beneficial to provide an economical alternative to both standard spray and the above identified special application sprinklers for the fire protection of attic and other sloped ceiling, combustible concealed spaces.

it would be beneficial to be able to provide fire protection systems in attics and other sloped ceiling, combustible concealed spaces that can provide quicker response times than the above identified back to back and single direction sprinklers.

It would be beneficial to be able to provide greater flexibility in both sprinkler selection and positioning in attic and other combustible concealed spaces for more effective fire protection.

It would be beneficial to be able to provide effective fire protection systems in attics and other light hazard, combustible concealed spaces while delivering less than 0.1 gallon per minute per square foot of area covered by such systems.

### BRIEF SUMMARY OF THE INVENTION

Briefly stated, a preferred embodiment of the present invention comprises a sprinkler system installed to protect a combustible concealed space between a floor protected by the system and a sloped root over the floor. The system includes a water supply line. A first valve has a body with an inlet fluidly connected with the water supply line, a first outlet and a passageway fluidly connect the inlet with at least the first outlet. The first valve further includes a seal member located in the body along the passageway, the seal member being supported in the body so as to move between a closed position and an open position to respectively block and open the passageway to fluid flow between the inlet and the first outlet. A first water discharge device is installed in the concealed space at a location remote from the first valve. The device is oriented to spray water delivered to the device onto at least a first portion of the floor. First piping fluidly connects the first water discharge device with the first outlet. A first thermal activation component includes a first thermally responsive element installed at a location in the concealed space remote from the first valve and the first water discharge device. A first flexible connector mechanically operably connects the first thermal activation component and the first valve. The first flexible connector initiates movement of the seal member from the closed to the open position in response to a physical change in the first thermally responsive element due to heating of the first thermally responsive element.

In another aspect, the present invention comprises a method of installing a fire protection system in a combustible concealed space within a structure between a sloped roof and a floor beneath the roof of the structure. The method includes: providing a water supply line to the system; fluidly connecting an inlet of a first valve with the water supply line, the first valve including a first outlet, a passageway fluidly connecting the inlet with the first outlet, and a seal member along the passageway, the seal member being a supported in the valve so as to move between a closed position and an open position to respectively block and open the passageway to fluid flow between the inlet and the first outlet; installing a first water discharge device at a location remote from the first valve and orienting the device to spray water delivered to the device onto at least a first portion of the floor; fluidly connecting at least the first water discharge device with the first outlet to receive water from the first valve; installing a first thermal activation component in the combustible concealed space at a location remote from the first valve and the first water discharge device, the first thermal activation component including a first thermally responsive element selected to undergo a physical change when heated to at least a predetermined temperature; mechanically operably connecting the first thermal activation component to the first valve with a first flexible connectors, the first flexible connector being connected with the valve so as to initiate movement of the seal member from the closed to the open position in response to the physical change of the first thermally responsive element in the first thermal activation component due to heating of the first thermally responsive element.

In another aspect, a preferred embodiment of the present invention comprises a sprinkler system installed to protect a combustible concealed space between a floor protected by the system and a sloped roof over the floor. The system includes a water supply line. A first valve has a body with an inlet fluidly connected with the water supply line, a first outlet and a passageway fluidly connecting the inlet with at least the first outlet. The first valve further includes a seal member located in the body along the passageway, the seal being supported in the body so as to move between a closed position and an open position to respectively block and open the passageway to fluid flow between the inlet and the first outlet. The first valve further includes a pivotable lever supporting the seal member across the passageway in a sealing position and secured in a sealing position by a pivotable latch engaged with the lever. The pivotable latch has a latch pivot point and forms a moment arm configured to provide a torque to rotate the pivotable latch about the latch pivot point. A first water discharge device is installed in the concealed space at a location remote from the first valve. The device is oriented to spray water delivered to the device onto at least a first portion of the floor. First piping fluidly connects the first water discharge device with the first outlet. A first thermal activation component includes a first thermally responsive element. A first flexible connector mechanically operably connects the first thermal activation component and the first valve. The first flexible connector initiates movement of the seal member from the closed to the open position in response to a physical change in the first thermally responsive element due to heating of the first thermally responsive clement. The first flexible connector includes a flexible wire having a first end and a second end and passing through at least a portion of the first piping, the first end operably connected to the moment arm and the second end operably connected to the first thermally responsive element.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a left front perspective view of a fire protection system installed in an attic in accordance with a preferred embodiment of the present invention;

FIG. 2 is an enlarged perspective view of a valve component of the system of FIG. 1;

FIG. 3A is an enlarged perspective view of a dry sprinkler device made with a preaction valve assembly in accordance with a preferred embodiment of the present invention;

FIGS. 3B and 3C arc enlarged elevational sectional views of the valve component and flexible connector of FIG. 3A showing activation of the valve from a closed state to an open state, respectively;

FIG. 4A is an enlarged devotional sectional view of an assembly in accordance with a preferred embodiment of the invention, shown prior to activation of the assembly;

FIG. 4B is an enlarged elevational sectional view of the assembly of FIG. 4A following activation of the assembly;

FIG. 5 is an enlarged front elevational view of an activation component with a micro switch in accordance with a preferred embodiment of the present invention;

FIG. 6 is a front right perspective view of a valve component and water discharge devices connected with a branch supply line in accordance with a preferred embodiment of the present invention;

FIG. 7 is a diagrammatic front elevational view of a system in installed in an attic accordance with a preferred embodiment of the present invention;

FIG. 8 is a diagrammatic top plan view of the protection system of FIGS. 1 and 6-7;

FIG. 9 is a left front perspective view of a fire protection system installed in an attic in accordance with a preferred embodiment of the present invention including three water discharge devices;

FIG. 10 is a front right perspective view of a valve and the water discharge devices of one of the preaction valve assemblies of the fire protection system of FIG. 9;

FIG. 11 is a diagrammatic front elevational view of the valve and water discharge devices of FIGS. 9 and 10 installed in an attic;

FIG. 12 a diagrammatic front elevational view of a tire protection system installed in an attic utilizing four discharge devices with each preaction valve assembly in accordance with a preferred embodiment of the present invention;

FIG. 13 is a diagrammatic front elevational view of a fire protection system installed in an attic utilizing five discharge devices with each preaction valve assembly in accordance with a preferred embodiment of the present invention;

FIG. 14 a diagrammatic front elevational view of a fire protection system installed in an attic in accordance with a preferred embodiment of the present invention;

FIG. 15 is a front right perspective view of one valve component and the water discharge devices connected with the branch supply line of the system of FIG. 14;

FIG. 16 is a diagrammatic front elevational view of a fire protection system installed in an attic utilizing four sprinklers with each preaction valve assembly in accordance with a preferred embodiment of the present invention;

FIG. 17 is a diagrammatic plan view of the fire protection system of FIG. 16;

FIGS. 18A and 18B are enlarged front left perspective and devotional sectional views of a valve component with two outlets in accordance with a preferred embodiment of the present invention;

FIG. 19 is a diagrammatic front right perspective view of a fire protection system of the present invention installed in a combustible concealed space subject to freezing temperatures;

FIG. 20 is a diagrammatic front elevational view showing the water discharge devices of the configuration of FIG. 19 mounted at various heights in order to vary the coverage areas of the devices by adjusting the orientations of the devices;

FIG. 21 is a diagrammatic front elevational view of a system providing protection in a combustible concealed space subject to a space subject to freezing temperatures in accordance with a preferred embodiment of the present invention;

FIG. 22A is an enlarged front right perspective view of a valve component of a preaction sprinkler valve assembly in accordance with a preferred embodiment of the present invention;

FIG. 22B is an enlarged elevational sectional view of the valve component of FIG. 22 before activation;

FIG. 22C is an enlarged left front perspective view of a lever-latch assembly mounted to a removable cover of the valve component of FIGS. 22A and 22B; and

FIGS. 23A and 23B are enlarged partial elevational sectional views of an additional form of a system according to the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The words “inner” and “outer” refer to directions toward and away from, respectively, the geometric center of the device and designated parts thereof. Unless specifically set forth herein, the terms “a”, “an” and “the” are not limited to one element but instead should be read as meaning “at least one”. The terminology includes the words noted above, derivatives thereof and words of similar import.

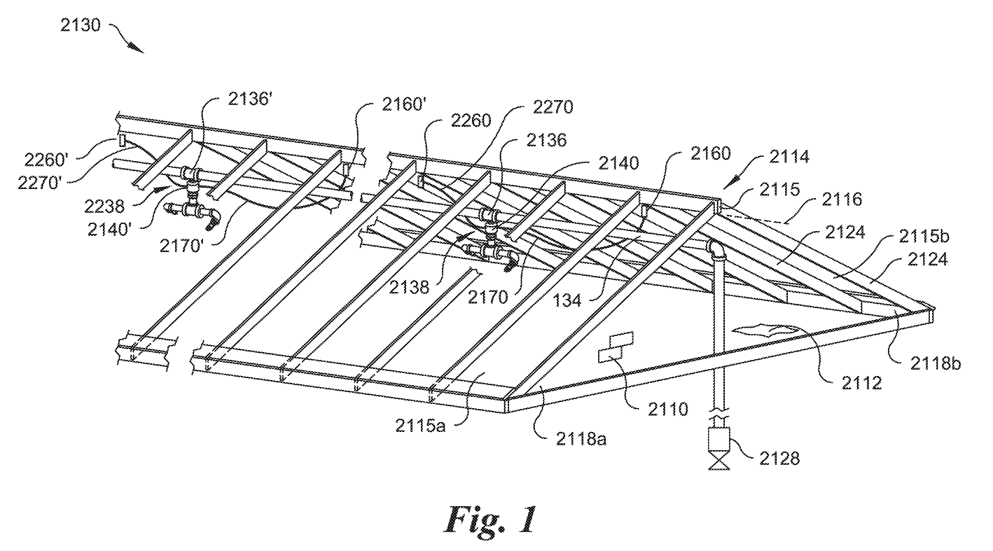

Referring to the drawings in detail, wherein like numerals indicate like elements throughout, FIGS. 1 and 7-8 show a fire protection system 2130 according to the present invention, in particular, installed to protect an attic “combustible concealed space” indicated generally at 2110 beneath a sloped or pitched roof 2114. In this example, a combustible concealed space 2110 exists between a top area formed by the pitched roof 2114 and an underlying area or “floor” 2112, where it is understood that “floor” is intended to broadly encompass the underlying surface which may be an actual load-bearing deck or the wooden structural members (e.g. joists, trusses) supporting a non-load-bearing ceiling of a space below the concealed space 2110. For convenience, all of these variations are referred to as “the floor.” The roof 2114 has sloping sides or pitches 2115a, 2115b descending from a peak 2116 where the sides 2115a, 2115b extend to eaves 2118a, 2118b at the ends of the sides 2115a, 2115b distal to the peak 2116. Referring to FIG. 8, which is the horizontal footprint projection of the sloped roof 2114 (See FIG. 1), on the floor 2112, the concealed space 2110 also has two end boundaries 2120, 2122, respectively, which may be exterior walls as depicted, or interior walls or borders of adjoining concealed space area(s) protected by other types of tire protection systems.

In a preferred embodiment of the present invention as shown in FIGS. 1 and 7-8, a sprinkler system 2130 is installed to protect a combustible concealed space 2110 between a floor 2112 protected by the system 2130 and a sloped roof 2114 over the floor 2112. The system includes a riser 2132 supplying water from below the floor 2112 and a water supply line 2134 branching off horizontally from the riser 2132 between the roof and floor areas 2114 and 2112, in this embodiment, proximate to the peak 2116 as is conventional in such fire protection systems. The water supply line 2134 runs horizontally through the combustible concealed space 2110 and optionally may be tilled with a pressurized gas.

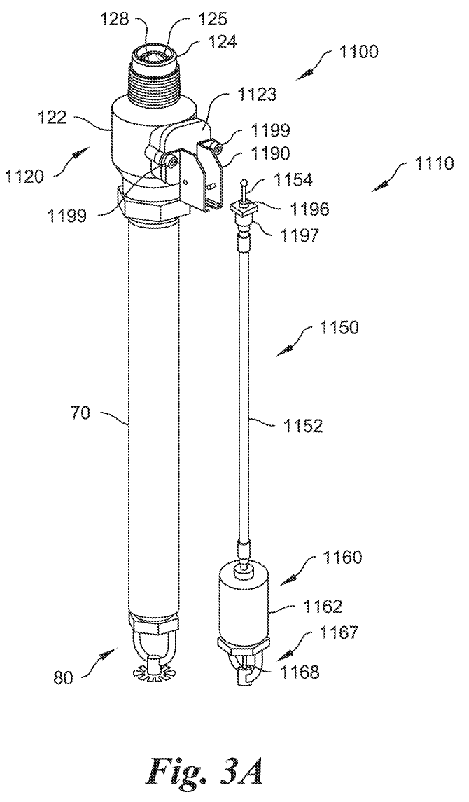

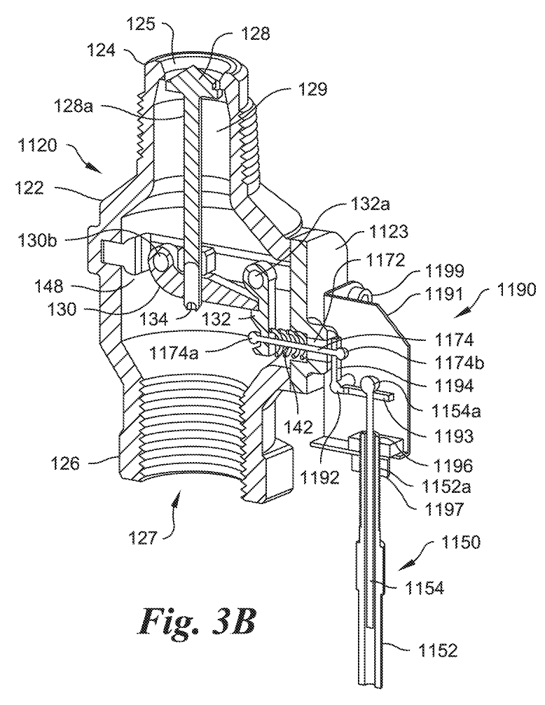

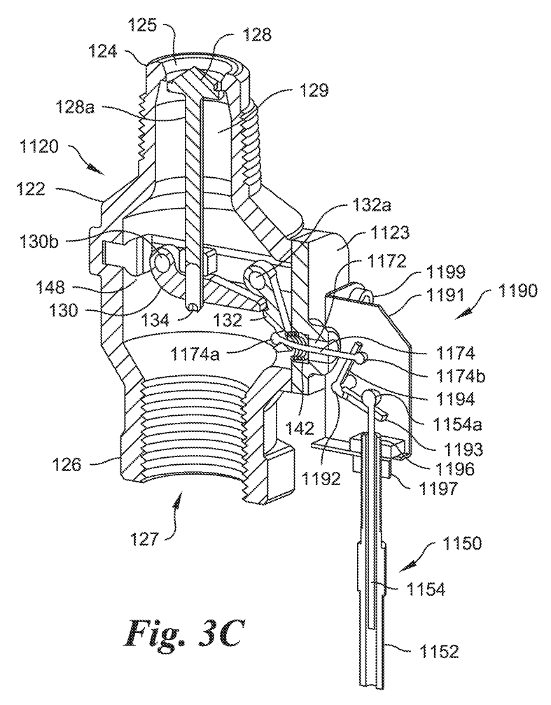

A valve 2140, 2140′ (a preaction valve) is fluidly connected with the water supply line 2134 as part of a preaction valve assembly 2138, 2238′, each of which also includes thermal activation assemblies 2160, 2260 and 2160′, 2260′ (discussed further below) connected to the valves 2140, 2140′ by flexible connectors 2170, 2270 and 2170′, 2270′ (also discussed further below). The details of several embodiments of preaction valves are discussed below with respect to FIGS. 3B, 3C, 4A, 4B, 18A, 18B, 22A, 22B, 22C, 23A, and 23B.

Again referring to FIGS. 1 and 7-8, a first water discharge device 2152 and a second water discharge device 2252 are installed in the concealed space 2110 at a location remote from the valve 2140. The first water discharge device 2152 and the second water discharge device 2252 are oriented to spray water delivered to each respective device onto at least a respective portion of the floor 2112. The first water discharge device 2152 and the second water discharge device 2252 each may be any of an open pendent (without a thermally responsive element and plug), upright, sidewall, conventional, or single direction sprinkler and a nozzle. The second water discharge device 2252 is installed in the combustible concealed space 2110 distanced from the first valve 2140, the first water discharge device 2152 and the first and second thermal activation assemblies 2160 and 2260 (described below). Each valve 2140, 2140′, together with respective connected thermal activation components 2160, 2260 and 2160′, 2260′ and flexible connectors 2170, 2270 and 2170′, 2270′, forms a thermal activation assembly 2138, 2238.

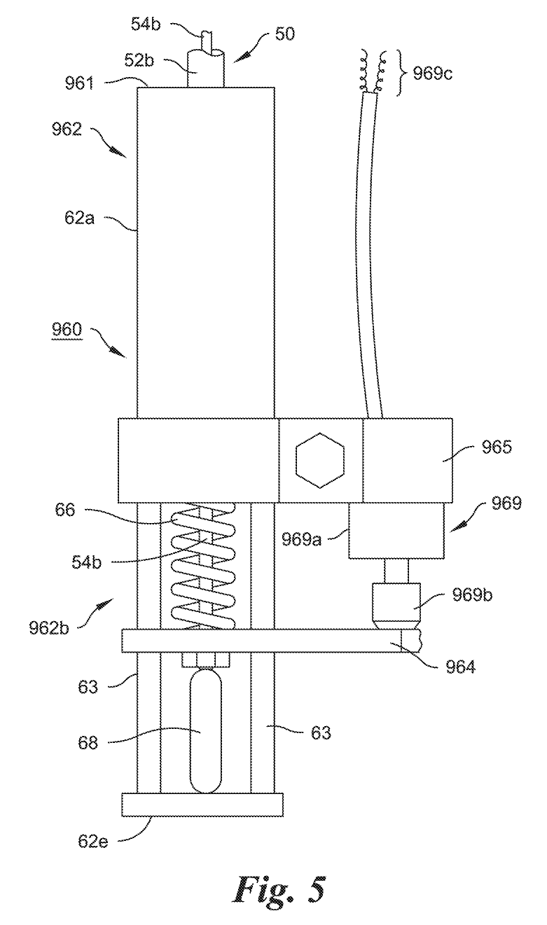

The first thermal activation component 2160 including a first thermally responsive element (not shown in FIG. 1) is installed at a location in the combustible concealed space 2110 remote from the first valve 2140 and the first water discharge device 2152. A first flexible connector 2170 mechanically operably connects the first thermal activation component 2160 and the first valve 2140. The details of a thermally responsive element and a flexible connector are described in connection with FIGS. 5A and 5B. A second thermal activation component 2260 includes a second thermally responsive element (not shown), the second thermal activation component 2260 being installed at a location spaced apart from the first valve 2140, the first water discharge device 2152, and the first thermal activation component 2160. A second flexible connector 2270 mechanically operably connects the second thermal activation assembly 2260 and the first valve 2140. The first and second thermal activation assemblies 2160. 2260 are laterally spaced apart from one another along the peak 2116 of the sloped roof 2114 and each is spaced from the valve 2140 by a distance less than seven feet, and in some embodiments a distance of no more than six feet, measured along the peak 2116. Note that some roofs include a flat roof section adjacent to or surrounded by a pitched section. The present invention is not limited to a system used solely in a concealed space covered by a pitched section of roof, but may also extend to an adjacent or surrounding flat roof section.

The first valve 2140 is supported on the water supply line 2134 at a height above the floor 2112 completely below a height of the first thermal activation component 2160 above the floor 2112, and the first water discharge device 2152 is supported a height above the floor 2112 completely below the height of the first valve 2140.

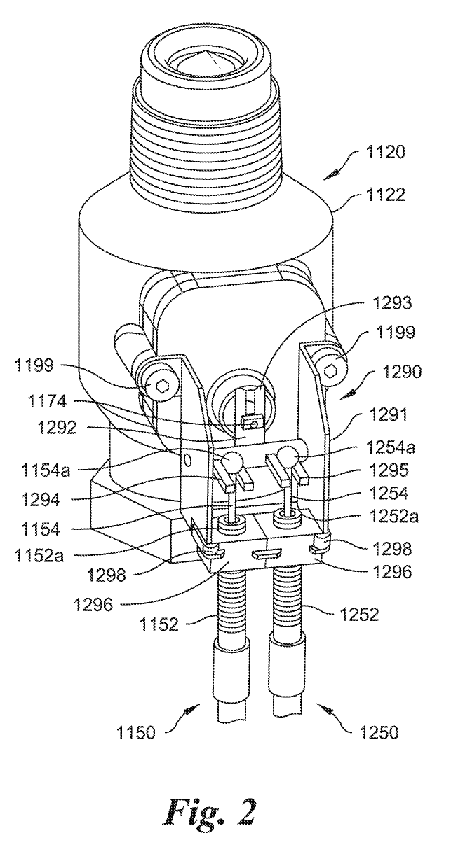

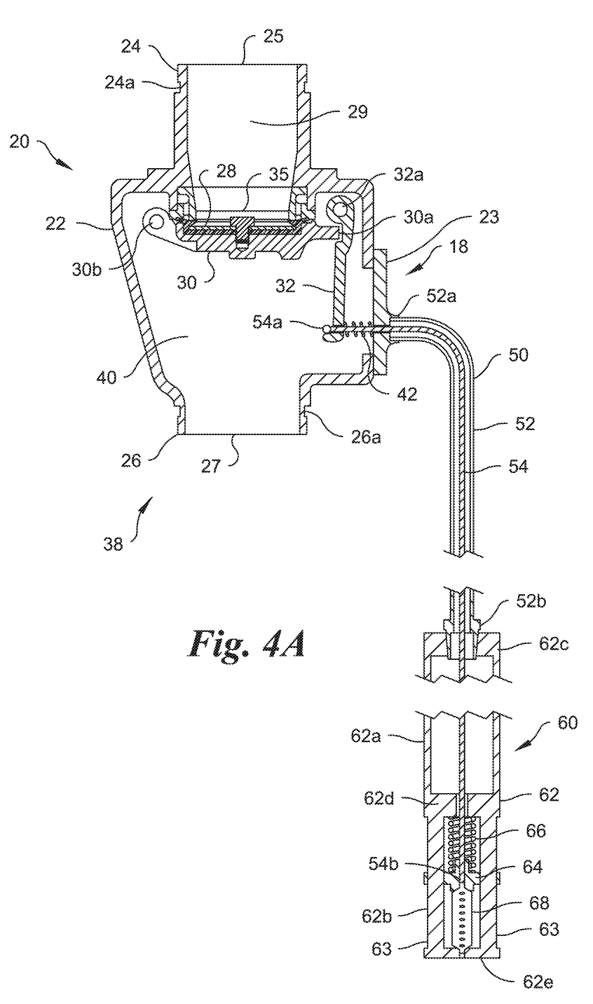

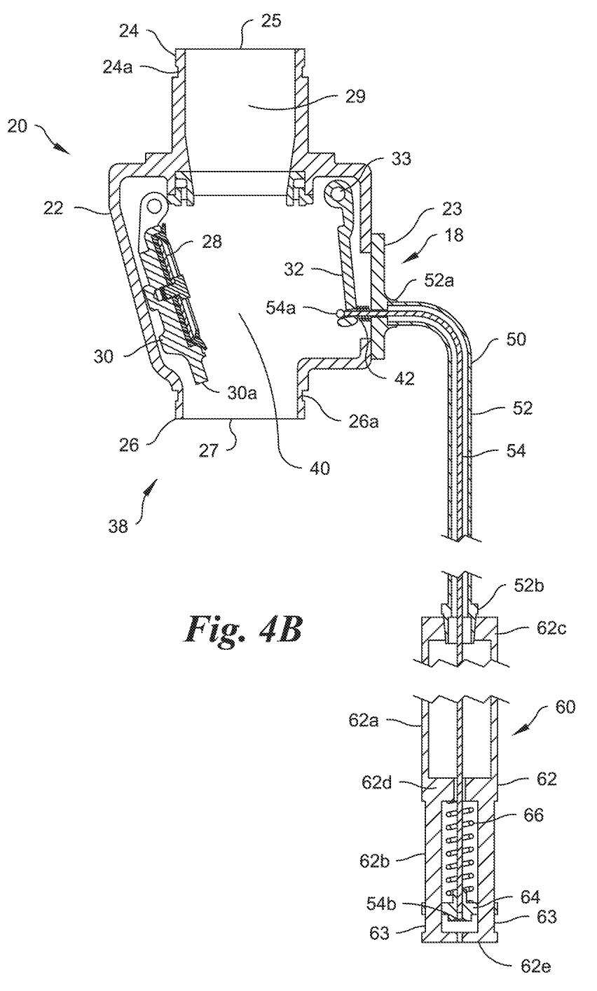

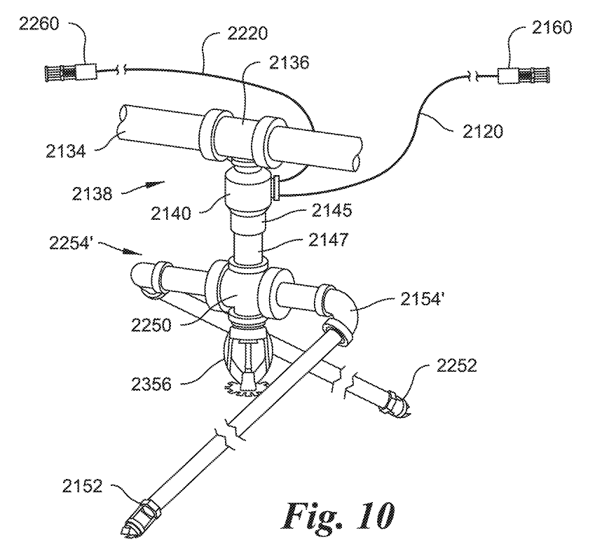

Referring to FIGS. 2 and 3A-3C, a mechanism 1290 connects first and second flexible connectors 1150, 1250 to a valve component 1120. In this embodiment, the mechanism is a bracket assembly 1290, which has a frame 1291 supporting a crank 1292, which has three arms 1293, 1294 and 1295. The crank 1292 is connected to a link 1174 by the first arm 1293. The second and third arms 1294 and 1295 are parallel to one another and offset 90° from the first arm 1293. The third arm 1295 connects with an end of the second flexible connector 1250 connected to a second thermal activation component (not depicted but like 60 in FIGS. 4A and 4B). In this embodiment, each flexible connector 1150 and 1250 is connected with the bracket 1291 by a single threaded member 1296, which can be adjusted along the first end 1152a, 1252a of the outer cable housing 1152, 1252 of either flexible member 1150, 1250, Each threaded member 1296 has slots on the opposing lateral sides which slide into and engage portions of the bracket 1291 forming mating slots. A spring arm 1298 retains each member 1296 in a corresponding slot. The first end 1154a, 1254a of each flexible cable 1154, 1254 of each flexible connector 1150, 1250 is engaged with a respective arm 1294, 1295 of the crank 1292 to be in mechanical operative connection with the latch 132 through the crank 1292. Movement by either cable 1154, 1254 pulls downwardly on the connected arm 1294, 1295 of the crank 1292, which pulls the link 1174 away from the body 1122 of the valve component 1120, thus triggering the valve component 1120 to permit water to flow from the inlet 125 through the outlet 127 and the pipe 70, with the water being discharged through the water discharge device (sprinkler) 80. The invention includes systems with individual valves connected to two or more thermal activation components as shown in FIGS. 1-2, 6-17, and 19-21, as well as systems where an individual valve is connected to a single thermal activation component, as shown in FIGS. 3A-3C and 4A-4B.

Referring to FIG. 3A, a dry sprinkler device 1100 of the present invention includes a thermal activation assembly 1110 with a valve component 1120, a flexible connector 1150, and a thermal activation component 1160. The valve component 1120 and the proximal end of the flexible connector 1150 are shown in cross section in FIGS. 3B and 3C.

The valve component 1120 includes a body 122 with an inlet end 124 having an inlet 125, which is externally threaded so as to be received in a tee fitting or in another type of fitting connection from a water supply line. An outlet end 126 has an outlet 127, which is internally threaded to receive an externally threaded length of pipe 70 (fabricated by an installer), which receives a water discharge device—in this case a standard, open sprinkler 80. A seal member 128 is supported in a passageway 129 through the body 122 between the inlet 125 and the outlet 127 by a lever 130 retained in a “closed” or “supporting” position by a latch 132. The seal member 128 is supported in the body 122 so as to move from a closed position (FIG. 3B) to an open position (FIG. 3C) to respectively block and open the passageway 129 to fluid flow between the inlet 125 and the outlet 127. The latch 132 pivots around a latch pivot 132a, which is a pinned connection. Similarly, the lever 130 pivots around a lever pivot 130b, which is also a pinned connection. An internal subassembly 148 supports a shaft portion 128a of the seal assembly 128 and pivotally supports the lever 130 and latch 132. The subassembly 148 is secured to a cover 1123, which is removably attached to the remainder of the body 122. In addition to the subassembly 148, in this embodiment, a crank assembly 1190 is secured to the body 122 with the cover 1123 using the same removable fasteners 1199, which are used to secure the cover 1123 to the body 122. The crank assembly 1190 includes a bracket 1191 physically secured to the cover 1123 and pivotally supporting a crank 1192. The crank assembly 1190 including the crank 1192 disposed between and mechanically coupling the first end 1154a of the flexible cable 1154 to the latch 132. One forked arm 1194 of the crank 1192 receives one end 1174b of a link 1174, which extends through an opening 1172 in the cover 1123. An opposing end 1174a of the link 1174 is secured with the latch 132 at an end away from the latch pivot 132a. A bias member 142 in the form of a compressed coil spring is located between the cover 1123 and the end of the latch 132 to maintain the latch 132 engaged with the lever 130. The lever 130 includes an adjustment screw 134 located to contact a distal end of the shaft end 128a to vary mechanical compression applied to the seal member 128 by the lever 130 in the closed position.

The latch 132 is operatively mechanically connected with the thermal activation component 1160 through the flexible connector 1150, the crank assembly 1190, the crank 1192, and the link 1174. The crank 1192 has another forked arm 1193 offset approximately 90° from the arm 1194. Again, the flexible connector 1150 is an assembly having a flexible outer cable housing 1152 slidably supporting a flexible inner cable 1154. A first end 1152a of the outer cable housing 1152 is preferably fixedly connected with the valve body 122 through the bracket 1191 by threaded members 1196, 1197 on the first end 1152a or the cable housing 1152. A first end 1154a of the flexible cable 1154 is received in the arm 1193 to operably mechanically connect with the latch 132 through the crank 1192 and the link 1174. Opening of the valve component 1120 from a closed configuration or state is illustrated in FIGS. 3B and 3C is accomplished by the flexible cable 1154 moving downwardly to rotate the crank 1192 which in turn pulls the link 1174 against the bias of the bias member 1142 which pulls the latch 132 to pivot counter clockwise and releases the lever 130 to move the seal member 128 downwardly to open the inlet 124.

The thermal activation component 1160 has the features of component 60 except the movable member 64 and the bias member 66 are now contained in a body/housing 1162. A standard sprinkler 1167 without a deflector but with a thermally responsive element 1168 is threaded into the end of body/housing 1162, and the plug (not depicted) of the standard sprinkler 1167 is used to restrain the movable member 64 until the thermally responsive element 1168 fractures.

Details of a first preferred valve 20, which is a clapper type valve, and of the flexible connector 50 and thermal activation component 60 of a thermal activation assembly 38 are shown in FIGS. 4A and 4B. The thermal activation component 60 has a base 62 and a movable member 64 that is movable with respect to the base 62. A bias member or spring 66 is located with respect to the base 62 to bias the movable member 64 from a preactivation position, shown in FIG. 4A, with respect to the base 62 to an activated position, shown in FIG. 4B, with respect to the base 62, The bias member 66 is selected to generate a force overcoming the bias of any opposing bias member—in this example, a bias member 42, discussed below—and to move a movable part, a latch 32 of the other component, the valve 20. A thermally responsive element 68 retains the movable member 64 in the preactivation position only until a predetermined thermodynamic condition is reached. The thermally responsive element 68 is configured to lose structural integrity under the predetermined thermodynamic condition. The flexible connector 50 includes at least a flexible hollow outer cable housing 52 with a first end 52a connected with the body 22 of the valve 20 and a second end 52b configured to be at least stationarily connected with the base 62. The base 62 includes an upper, spacer portion 62a from which extends a sensing portion 62b. The housing 62 may be one piece but might conveniently be made of an assembly of joined parts. The flexible connector 50 includes a flexible inner member 54 with opposing first 54a and second 54b ends. The first end 54a of the flexible inner member 54 is slidably located inside the flexible hollow outer cable housing 52 and configured to be mechanically connected with and preferably fixedly connected with the movable part, the latch 32 of the valve 20, while the second, opposing, remaining end 54b is configured to be mechanically and preferably fixedly connected with the movable member 64 so as to move with the movable member 64, The second end of the outer cover 52b is received in and preferably fixedly connected with the upper end 62c of the spacer portion 62a of the base 62. As shown in FIGS. 4A and 4B, the first end 52a of the flexible hollow outer cable housing 52 is configured for stationary and preferably fixed connection with the other tire protection component or valve 20 and preferably to the body 22 of the clapper valve 20.

The flexible connector 50 is preferably a Bowden cable in which the flexible inner member 54 is slidably located inside the flexible outer cable housing (or flexible outer tube) 52 for only sliding movement within the flexible outer cable housing 52. The phrase, only sliding movement, as used herein, means that the flexible inner member 54 is sufficiently closely received and Fitting in the outer housing 52 that the inner member cannot buckle or meaningfully deflect within the outer housing 52 so that there is no lost movement or essentially no lost movement between the ends 54a, 54b of the flexible inner member 54 within the outer housing 52. The flexible inner member 54 is moved with respect to the flexible hollow outer cable housing 52 by movement of the movable member 64 with loss of structural integrity by the thermally responsive element 68 under the predetermined thermodynamic condition. The thermally responsive element 68 may include alcohol- or other liquid-Filled glass bulbs, fusible links (1168 in FIG. 3A), other solder-based links or assemblies which fail in response to being heated sufficiently to at least a predetermined temperature, permitting movement to occur, bi-metallic disks, and other thermally responsive elements known in the art. The flexible inner member 54 may be a single flexible wire or a flexible cable made from a bundle of wires. Hereinafter the flexible inner member 54 may also be referred to as simply the flexible cable.

In the embodiment depicted in FIGS. 4A and 4B, the member 64 of the activation component 60 is slidably mounted on the sensing portion 62b of the base 62. The sensing portion 62b might be formed by a pair of rods 63 extended between an intermediate transverse portion 62d, which might be the bottom transverse wall of a cylinder forming the spacer portion 62a and receiving a cap forming the upper end 62c of the housing and supporting the rods 63 themselves supporting the bottom transverse portion 62e. In a preactivation position of the device, the movable member 64 is restrained by the thermally sensitive element 68. The transverse portions 62d and 62e provide the resistive support of the bias member 66 and thermally sensitive element 68, respectively.

As depicted in FIGS. 4A and 4B, the other fire protection component 20 is a clapper valve 20 according to a preferred embodiment of the invention. The valve 20 has a body 22 with an inlet end 24 and an inlet 25, an outlet end 26 with an outlet 27, and a fluid passageway 29 between the inlet 25 and the outlet 27. The inlet end 24 has a groove 24a for connecting to a water supply. The outlet end 26 has a groove 26a for connecting to a sprinkler head or other water distribution device or system. Other forms of connection, such as threaded connections, could be used at the inlet end 24, the outlet end 26, or both ends. A removable cover 23 provides access to the interior of the body 22 and is attached to the first end 52a of the flexible hollow outer cable housing 52. A seal member 28 is supportable across the passageway 29 to close the passageway 29 by a pivotable lever 30 with a tang 30a. The seal member 28 is supportable across the passageway 29 in a sealing position by a latch 32 engaged with the tang 30a of the lever 30. A screw 35 secures the seal member 28 to the lever 30. A flexible connector in the form of the flexible cable 54 has the first end 54a mechanically coupled with the latch 32 for movement of the latch 32 with respect to the lever 30 by movement of the first end 54a of the flexible cable 54. The latch 32 pivots around a latch pivot 32a, which is a pinned connection. Similarly, the lever 30 pivots around a lever pivot 30b, which is also a pinned connection. The pressure of water at the inlet 25 forces the seal member 28 and the lever 30 back away from the inlet 25 and into the passageway or central chamber 40, permitting water to flow around past the lever 30 and the latch 32 and through the outlet 27. Thus the flexible connector, cable 54, initiates movement of the seal member 28 from the closed position (FIG. 4A) to the open position (FIG. 4B) in response to a physical change in the thermally responsive element 68 due to heating of the thermally responsive element. At least one of a fire sprinkler and another valve is preferably fluidly connected to the outlet 27.

FIG. 5 depicts a slightly modified activation component 960 that is connected through a flexible connector 50 to a valve component such as 20 (FIG. 4A-4B) or 1120 (FIGS. 2, 3A-3C). The flexible connector 50 preferably has a flexible outer cable housing with second end 52b slidably supporting a flexible cable having a second end 54b. The activation component 960 includes a base 962 that includes an upper, spacer portion 62a identical to that of component 60 (FIGS. 4A-4B) from which extends a sensing portion 962b. The second end of the outer cable housing 52b is received in the transverse distal/upper end 961 of a spacer portion 962a. The second end 54b of the flexible cable is connected with a movable member 964 slidably mounted with respect to the sensing portion 962b of the housing 62 on a pair of rods 63. A bias member 66, which as depicted is a compressed coil spring, biases the movable member 964 holding the second end 54b of the cable away from the spacer portion 962a. In preactivation position of the device, the movable member 964 is restrained by a thermally sensitive member 68.

A switch 969, which may be a micro switch, changes state with operation of the activation component 960; any switch of capacity suitable to the switched current and dimensions suitable to the geometry of the activation component 960 may be used. The micro switch 969 has a main body 969a, a movable actuation button 969b and electrical leads 969c. The body 969a of switch 969 is supported from the spacer portion 62a by means of a bracket 965. Triggering of the activation component 960 by breakage of the thermally responsive element 68 allows the bias member 66 to force the movable member 964 towards the lower end plate 62e releasing the button 969b to allow the switch 969 to change states. The two leads 969c are provided for electrical connection to the switch 969 for control of electrical equipment such as alarms or electronic controllers (not depicted). Thus the thermal activation component 960 for use in a thermal activation assembly includes a switch 969 mounted on the activation component so as to change states with movement of the movable member 964.

The switch 969 and the bracket 965 may be supplied as an accessory to a basic activation component 960 that differs from the activation component 60 (FIGS. 4A and 4B) by the modified movable member 964. Still other arrangements will occur to those of ordinary skill in the art. It will be appreciated that the switch 969 should preferably be mounted as depicted or in some other way so as to be removable to test operation without triggering the activation component 960.

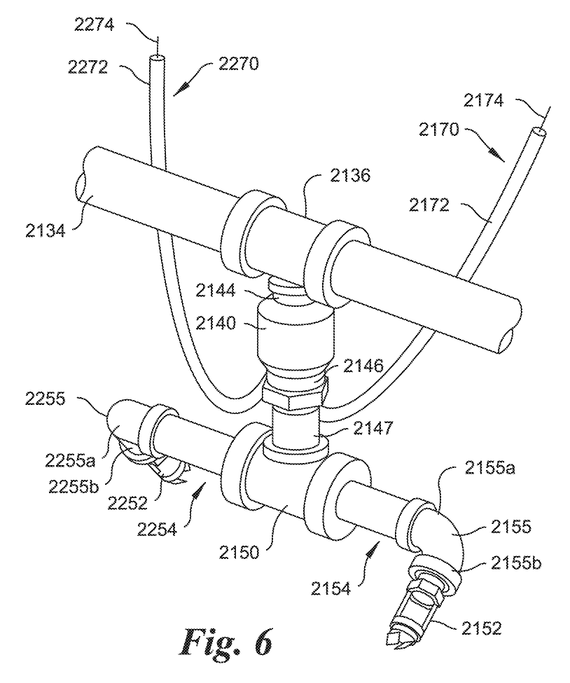

In FIG. 6, the inlet of a tee 2150 is fluidly connected to the outlet 2146 of a valve 2140 by piping 2147. First and second water discharge devices 2152, 2252 are fluidly connected to opposite outlet sides of the tee 2150 by first and second piping 2154, 2254, respectively. The tee 2150 connects the first water discharge device 2152 and the first piping 2154 with the outlet 2146 of the valve 2140. The second piping 2254 fluidly connects the second water discharge device 2252 with the outlet 2146 of the valve 2140. In this embodiment, each piping, 2154, 2254 includes a 90° elbow 2155, 2255. Each elbow 2155, 2255 has an inlet arm 2155a, 2255a connected with one outlet of the tee 2150 and a remaining arm 2155b, 2255b the centerline of which is normally collinear with the centerline of the sprinkler discharge orifice and is aimed to obtain the desired coverage area. In this embodiment, each discharge device 2152, 2252 is preferably an open, horizontal side wall sprinkler having a discharge orifice collinear with the centerline of the remaining arm 2155b, 2255b and preferably having an oblong water throw pattern defining a generally rectangular coverage area on the floor 2112 beneath and outward of the sprinkler 2152, 2252, The discharge device 2252 and piping 2254 are symmetric duplicates of the device 2152 and piping 2154.

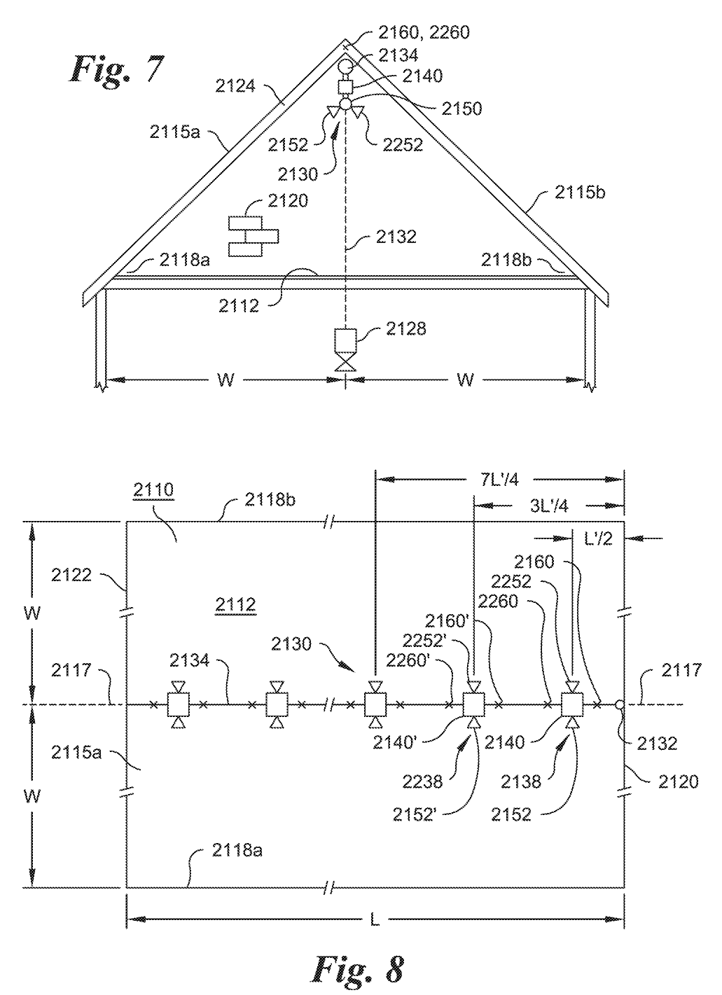

Referring to FIGS. 7 and 8, the preaction valve assembly 2138 and two water discharge devices 2152, 2252 provide fire protection over a floor area L long as measured along a ridge line 2117 defined by the peak 2116 from end wall 2120 and 2W wide in directions perpendicular to and extending in either direction from the ridge line 2117. For example purposes, the distance between end walls 2120, 2122 is taken to be 180 feet, Each discharge device 2152, 2252 is responsible for providing coverage of a floor area of W×L under the respective pitch 2115a, 2115b.

A preferred arrangement of the first preaction valve assembly 2138 includes the valve component 2140 located closest to the feed pipe/riser 2132 being preferably positioned a distance approximately L′/2 measured from the proximal end wall 2120 of the concealed space 2110 parallel to the ridge line 2117, where L′ actually equals the width (direction perpendicular to the outlet centerline) of the designated coverage area of the identical discharge devices 2152, 2252 connected with the valve 2140 at their supplied water pressure. The positioning of the valve 2140 is not critical as long as the required positions of the discharge devices 2152, 2252 and desired positions of the thermal activation components 2160, 2260 are met. W′ represents the length of the listed coverage area of each of the discharge devices 2152, 2252 on floor 2112 from the peak 2116 to an eave 2118a, 2118b and is related to the maximum outward throw distance of the device 2152, 2252 providing the listed water density delivered by the device 2152, 2252 at a listed water delivery pressure. The throw of the discharge devices 2152, 2252 positioned proximal the peak 2116 is measured along the respective pitches 2115a, 2115b of the roof 2114. (The coverage areas of the previously mentioned special back-to-back and single direction application sprinklers are a maximum of 60 and 40 feet respectively measured along the floor 2112. This means that the throws of the sprinklers are longer than 60 and 40 feet, sufficiently long to reach the maximum coverage distances at the steepest roof pitches, up to 12 over 12 (12/12 meaning rise over run), for which those sprinklers are listed.

To provide a uniform spacing of the thermal activation components 2160, 2260, etc. throughout the 180 foot long concealed space 2110, a first thermal activation component 2160 is preferably located most proximal to the end wall 2120 at a distance approximately L′/4 (3 feet) from the end wall 2120 as measured along the ridge line 2117 and is positioned in a location proximal the peak 2116 to most optimally be exposed to heat from a fire in the coverage area L′/2 (6 feet) between the end wall 2120 and the valve 2140 and 2W between the eaves 2118a, 2118b. Again, for convenience, the valve 2140 is located a distance approximately L′/2 (6 feet) from the end wall 2120. The second thermal activation component 2260 is more distal to the end wall 2120 than component 2160 and is preferably located a distance approximately 3L′/4 (9 feet) from the end wall 2120, again measured along the ridge line 2117. The second thermal activation component 2260 is also positioned in a location proximal the peak 2116 to most optimally be exposed to heat from a fire anywhere beneath a coverage area 2W wide and extending between L′/2 and L′ (6 and 12 feet) from the end wall 2120. If the valve 2140 is positioned at L′/2 (6 feet) from end wall 2122, the valve 2140 is spaced apart equally from each thermal activation component 2160, 2260 (L′/4 or 3 feet along 117) and each thermal activation component 2160, 2260 is responsible for monitoring an identical portion of the concealed space measuring L′/2 (6 feet) along ridge line 2117 and W in either direction perpendicular to the ridge line 2117. The described arrangement also enables centering of the discharge devices along the peak 2116 with minimum piping between the valve 2140 and the connected discharge devices 2152, 2252.

The described spacing can and should be repeated for subsequent preaction valve assemblies installed along the peak 2116. FIGS. 1 and 8 show a second preaction valve assembly 2238 fluidly coupled with the branch line 2134 through a second tee 2236. Second assembly 2238 includes the same components 2140, 2160, 2260, 2170, 2270 as the first assembly 2138, and are identified in the figures by the same reference numbers but with the addition of an apostrophe ('). Each discharge device 2152′, 2252′ of the second assembly 2238 is the same as that 2152, 2252 of the first assembly 2138 and so has the same protection area of L′ by W on the floor 2112. A first thermal activation component 2160′ of the second assembly 2238 is located more proximal to the end wall 2120 and is spaced a distance L′/2 (6 feet) along the ridge line 2117 from the second thermal activation component 2260 of the first assembly 2138, positioned in a location proximal the peak 2116 to most optimally be exposed to heat from a fire anywhere on the floor 2112 between the eaves 2118 and between distances to L′/2 (12 to 18 feet) from end wall 2120. The second valve component 2140′ is preferably located, along the branch line 2134 a distance approximately 3L′/2 (18 feet)from the end wall 2120 so as to be a distance L′ (6 feet) from the first valve component 2140. The second thermal activation component 2260′ is located a distance approximately 7L′/4 (21 feet) from end wall 2120 and L′/2 (6 feet) from the first thermal activation component 2160′. In this way, fire protection coverage is provided repeatedly and uniformly along the length of the concealed space 2110 between the end boundaries 2120, 2122 by fifteen preaction valve assemblies 2138, 2238, etc. FIG. 7 is a diagrammatic end view of the system 2130 in which the final preaction valve assembly and the water distribution devices 2152, 2252 are indicated.

It will be appreciated that typically, unlike the situation shown in FIG. 8, the length of the combustible concealed area 2110 (measured along the ridge line 2117) is not an integer value of the width of the coverage areas of the discharge devices 2152, 2252. In that case, the installer would have the option of either uniformly shrinking the length of the coverage areas along the ridge line 2117 (so that coverage areas between adjoining preaction valve assemblies and their discharge devices would overlap) or providing different protection (e.g. lines of standard spray or special application sprinklers) in a smaller area, or simply shrinking one or more of the areas to provide overlapping or greater overlapping coverage in those areas. For example, the coverage areas adjacent the end walls 2120, 2122, particularly that closest to the riser 2132, might be reduced in length (L) to provide extra water in the area to protect the end wall(s) and the riser 2132. Still other arrangements are possible given the flexibility provided by the present invention.

Water discharge devices 2152, 2252, 2152′, 2252′ might be, for example, open Viking VK630 extended-coverage, horizontal-sidewall sprinklers. These sprinklers have a UL-listed, light-hazard, maximum extended coverage area width (L′ in the figures extending along the ridge line 2117) of 14 feet and a maximum outward throw of 26 feet in directions perpendicular to the ridge line 2117. Again, the maximum throw is to be measured along the pitches (sloping sides) 2115a, 2115b and so translates for each such sprinkler 2152, 2252 into a horizontal distance W on the floor 2112 of 25.2 feet for a pitch of 3/12; 23.25 feet for a pitch of 6/12; 20.8 feet for a pitch of 9/12; 20 feet for a pitch of 10/12; and 18.4 feet for a pitch of 12/12. Thus, the configuration of FIGS. 1 and 6-8 provides an overall protection area for each preaction valve assembly 2138 with these sprinklers 2152, 2252 of up to 14 feet measured parallel to ridge line 2117 and between 37 and 50 feet (2W) measured on the floor 2112 perpendicular to the ridge line 2117. Thus, except for the greatest pitches (11/12 or 12/12), this configuration provides coverage areas of between 40 and 50 feet (2W) wide extending between the eaves 2118a, 2118b. Assuming a maximum spacing of six feet between thermal activation components and thus twelve feet between adjoining valves and sets of discharge devices, there can be up to two feet of overlap of the coverage areas of consecutive preaction valve assemblies using existing sidewall sprinklers. However, the present invention further presents the possibility of designing, discharge devices with coverage areas that conform more closely to the existing restrictions (twelve feet along the peak 2116 for six foot separation of the thermal activation components 2160, 2260) and outward from thirty four feet and up to nearly fifty feet in order to provide up to thirty-three feet along the floor 2112 under a 3/12 pitch up to 12/12 pitch, respectively, sufficient to provide a maximum coverage area of almost four hundred square feet (twelve by thirty-three feet) per water discharge device 2152, 2252.

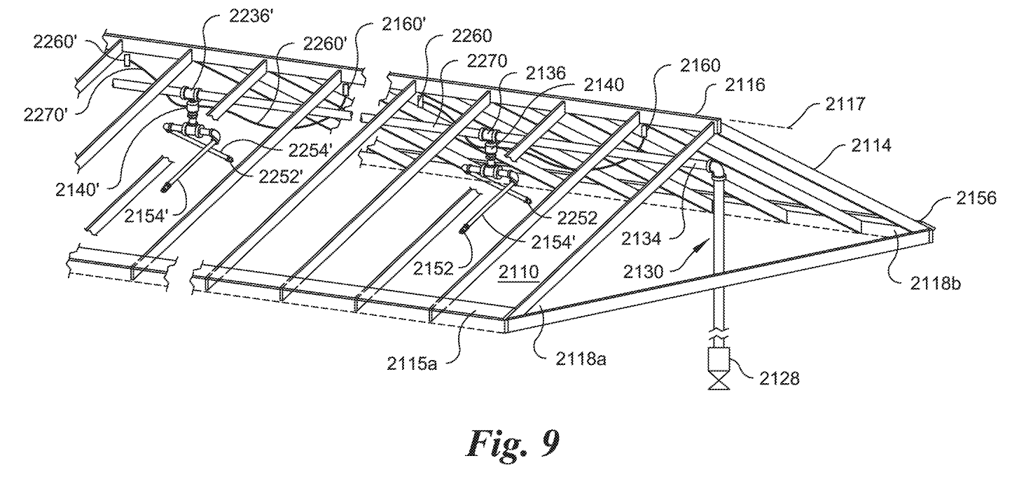

FIGS. 9 through 13 illustrate how these coverage area widths might be extended by the addition of one, two or even three extended-coverage, light-hazard, pendent (or upright) sprinklers.

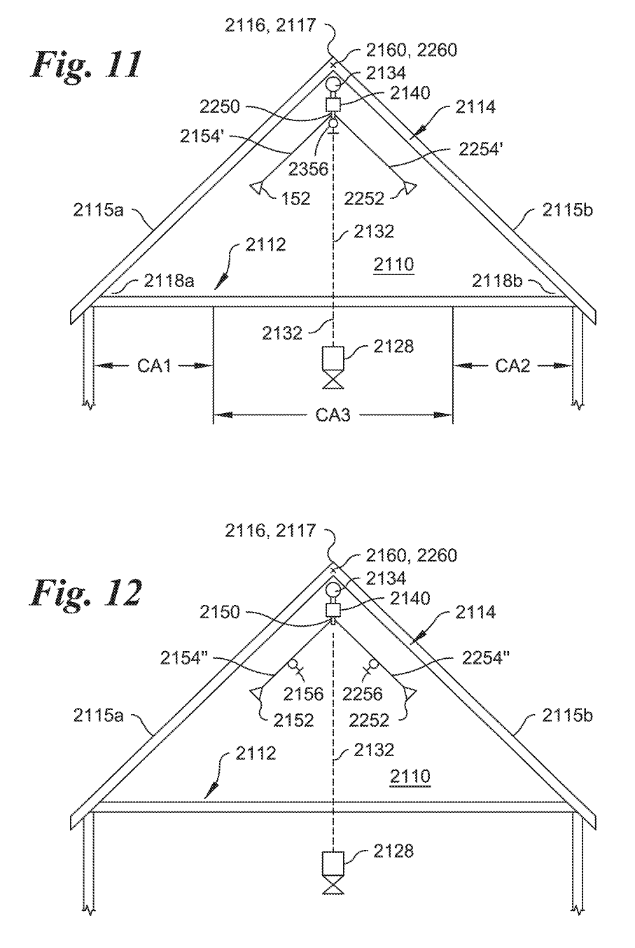

Referring to FIGS. 9-11, the outlet tee 2150 of each valve 2140 is replaced by a cross fitting 2250. An extended coverage, light hazard, pendent sprinkler 2356 could be suspended from the downward arm of the cross fitting 2250 directly below the valve 2140 a distance sufficient for the sprinkler 2356 to provide up to the maximum listed coverage area across the, floor 2112 or the maximum coverage area desired for the system. Side wall sprinklers 2152, 2252 are mounted at the end of piping 2154′, 2254′ extended along the roof pitches 2115a, 2115b from the horizontal arms of the cross fitting 2250, the extensive distances sufficiently long to position those sprinklers above the distal outer edges of the coverage area of the pendent sprinkler 2356 so as to abut if not overlap their coverages. The widths of the coverage areas of the three sprinklers along floor 2112 perpendicular to the ridge line 2117 (itself perpendicular to the figure) are indicated in FIG. 11 at CA1, CA2, CA3 for sprinklers 2152, 2252 and 2356. The coverage area of extended coverage pendent sprinkler 2356 may range from a minimum of 12 by 12 feet to the maximum of 20 by 20 feet. Use of an extended coverage sprinkler 2356 could therefore increase the total width (2W) of the collective coverage with sprinklers 2152 and 2252 from 12 to 20 additional feet over the configuration of FIGS. 1, 7 and 8. Both a first and a second thermal activation component 2160, 2260 are mechanically operably connected by the flexible connectors 2120, 2220 with the valve 2140, so that either the first or the second flexible connector 2120, 2220 initiates movement of the seal member (not shown, interior to valve 2140) from the closed to the open position in response to physical change of the first or second thermally responsive element (not shown) contained in the first or second thermal activation component 2160, 2260 due to heating of the first or second thermally responsive element.

Referring to FIG. 12, piping 2154″ and 2254″ from tee 2150 respectively support one identical pendent sprinkler 2156, 2256 and beyond them, one identical horizontal sidewall sprinkler 2152, 2252. In this configuration, the coverage area of each pendent 2156, 2256 is measured along the respective roof pitch. The up to 20 feet maximum throw distance that might be achieved by each standard, extended coverage, light hazard, pendent sprinkler 2156, 2256 parallel to the roof pitch is reduced when projected down to and measured along the floor 2112 to 19 feet for a 3/12 pitch, 18 feet for a 6/12 pitch, 16 feet for a 9/12 pitch, 15.4 feet for a 10/12 pitch and 14 feet for a 12/12 pitch. Those distances would be added to the aforesaid coverage distances of the sidewall sprinklers 2152, 2252.

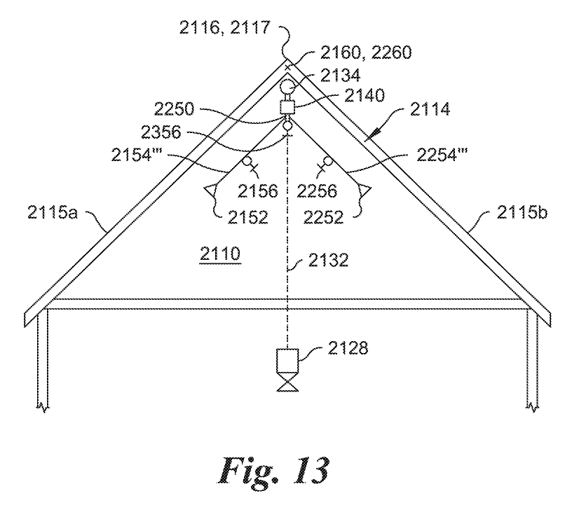

In FIG. 13, a cross fitting 2250 is again provided with the bottom arm supporting pendent sprinkler 2356 while piping 2154′″ and 2254′″ again respectively support pendent sprinklers 2156, 2256 sufficiently far down the respective pitch that the edges of their respective coverage areas most proximal the roof peak 2116 abut if not overlap the distal outer edges of the pendent sprinkler 2356. The horizontal sidewall sprinklers 2152, 2252 are again positioned above the distal outer edge of the coverage area of immediately inward pendent sprinkler 2156, 2256, respectively. The maximum dimension 2W of the combined coverage areas of the five sprinklers 2152, 2252, 2356, 2156, 2256 in the FIG. 13, all of which are supplied with water by the valve 2140, ranges from over 84 feet at a 12/12 pitch to over 100 feet for a 3/12 pitch. These exceed the longest throw dimension of the best currently available special application attic sprinklers, namely 40 feet for single direction sprinklers. Moreover, the length L measured in the direction of the ridge line 2117 of the combined coverage areas is at least 12 feet, double that of back to back and single direction attic sprinklers, while still maintaining no more than 6 feet separation between thermal activation components 2160, 2260. In almost all cases, it is possible to position those components 2160, 2260 even closer to the peak 2116 of the roof 2114 than back to back or single direction sprinklers can be positioned. Thermal activation components can be attached to the bottom of the top chord or a solid wood rafter or even closer to the peak between trusses or rafters, if such positioning is deemed advantageous for fire sensing.

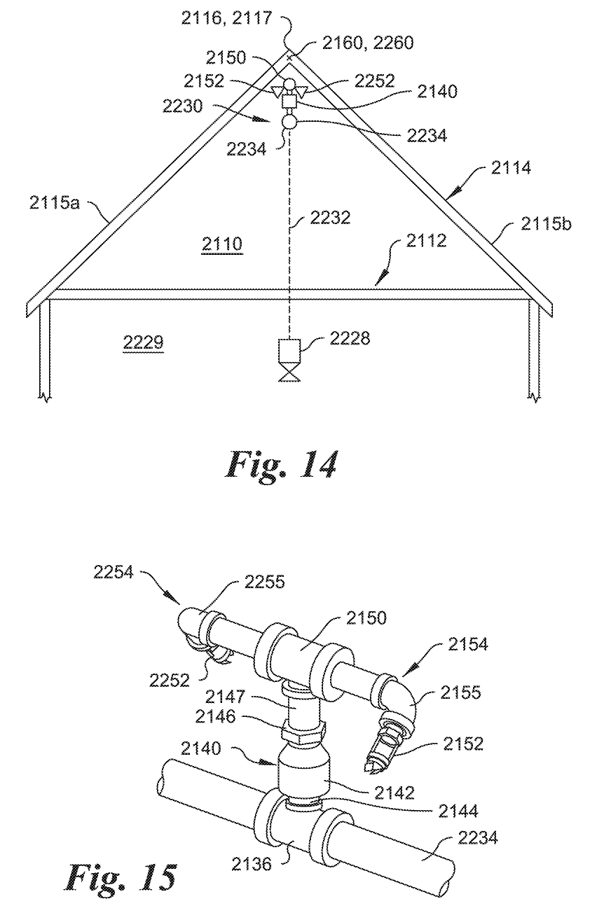

The sprinkler system configurations illustrated in FIGS. 1 and 6-13 with a downward directed outlet 2146 of each valve component 2140 are suitable only for wet systems. A dry fire protection system 2230 incorporating the present invention is partially illustrated diagrammatically in FIG. 14. In this system 2230, the riser 2232 extends upward 14 from a dry pipe valve 2228 located in a heated space 2229, in this instance, below the combustible concealed space 2110. The riser 2232 again connects with a single supply or branch line 2234 extended horizontally along the peak 2116 (out of the figure) and along which are spaced a number of tees (e.g. 2136 in FIG. 15) each installed with the transverse arm pointed upwardly and receiving a valve component 2140. In a dry system like 2230, the riser 2232 and branch lines 2234 are normally filled with pressurized gas to trigger operation of the dry valve 2228.

Referring to FIG. 15, the valve component 2140 is inverted from the orientation in FIGS. 1 and 6-13 with a downwardly pointing and lower positioned inlet 2144 coupled with the transverse upward directed arm of tee 2136 in supply line 2234 and the outlet 2146 pointed upwardly and positioned above the valve body 2142. The outlet 2146 receives a tee fitting 2150 which supplies through the piping 2154, 2254, one or more water discharge devices, again in this example, the horizontal sidewall sprinklers 2152, 2252, essentially duplicating the configuration of FIG. 1 and providing the same coverage areas as in FIG. 8.

The configuration of FIG. 12 could also be duplicated with the addition of piping 2154″, 2254″. It is also possible to duplicate the configurations of FIGS. 9 and 13, but the cross fitting 2250 mounted atop the valve 2140 would need to support an upright sprinkler over the valve 2140 in place of the pendent sprinkler 2356 below the valve in both examples.

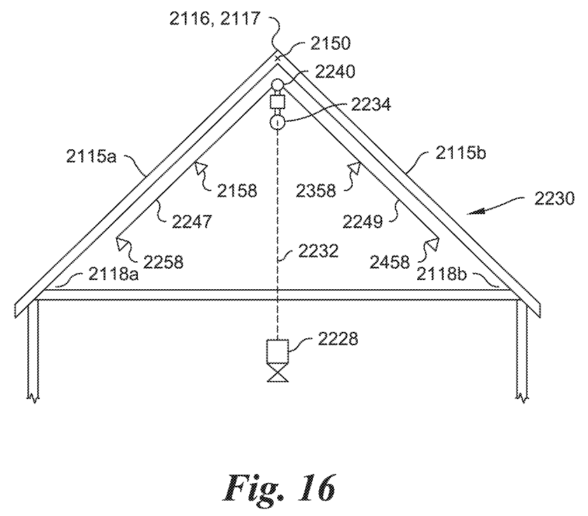

FIGS. 16 and 17 illustrate diagrammatically yet another possible configuration of a dry fire protection system 2230 to protect a coverage area span of 80 feet (2W) cave to cave 2118a, 2118b, with a 12/12 pitch. Consecutive preaction valve assemblies 2138, 2238, 2338 with identical valve components 2240, 2240′, 2240″, thermal activation components 2160, 2260, 2160′, 2260′, 2160″, 2260″ and flexible connectors 2170, 2270, 2170′, 2270′, 2170″, 2270″ are spaced along the branch supply line 2234 proximal the peak 2116, The spacing is as before with the first valve 2240 no more than 6 feet from end wall 2120 and subsequent valves 2240′, 2240″ are spaced no more than 12 feet apart from one another. A first activation component 2160 is spaced no more than 3 feet from the end wall 2120 and the subsequent activation components 2260, 2160′, etc. are spaced no more than 6 feet apart from one another along the peak 2116.

Referring to FIG. 16, piping 2247, 2249 extends approximately 6 feet outwardly from the valve 2240 parallel to the ridge line 2117 and then turns ninety degrees and continues down the slope of a separate side 2115a, 2115b, respectively, of roof 2114. Connected along, the piping 2247 by tees are two identical, open, wide-throw, horizontal sidewall sprinklers 2158, 2258 such as Viking VK638 extended coverage horizontal-sidewall sprinklers. Central axes of the outlets of these sprinklers are aimed perpendicular to the portion of piping 2247 extending along the pitch 2115a and parallel to the ridge line 2117 and away from end wall 2120. These sprinklers have maximum coverage areas 28 feet wide with a forward throw of only 12 feet at 18.1 psi and 14 feet at 25.0 psi. The former is sufficient. The first sprinkler 2158 is spaced approximately 14 feet down the side 2115a from the peak 2116 and the second sprinkler 2258 is spaced another 28 feet down the side 2115a from the first sprinkler providing 56 feet of continuous coverage along the pitch 2115a and 12 feet across the pitch 2115a away from the end wall 2120. With a 12/12 pitch, this converts to 40 feet along the floor 2112 beneath side 2115a. Piping 2249 extending in the opposite direction 6 feet away from valve 2240 along the peak 2116 and down the opposite side 2115b with the same type of horizontal sidewall sprinklers 2358, 2458 aimed across the opposing side 2115b parallel to the peak 2116 and opposite the directions of 2158, 2258 (i.e, aimed toward end wall 2120) to provide a coverage area on the floor 2112 of 12 feet (L′) measured along the ridge line 2117 and 40 feet wide (W) measured perpendicularly from the ridge line 2117 under side 2115b. Thus, as shown in FIG. 17, each preaction valve assembly 2138, 2238, etc. with the four sidewall sprinklers 2158, 2258, 258, 2458, collectively provides coverage over a floor area of 12 feet parallel to the ridge line 2117 with a span of 80 feet perpendicular to the ridge line 117.

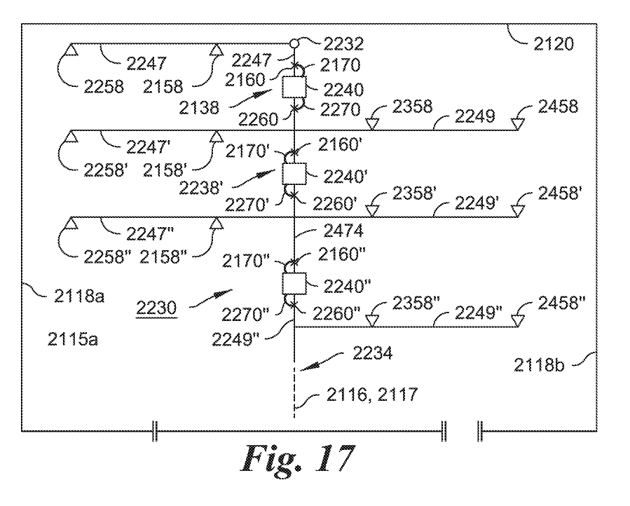

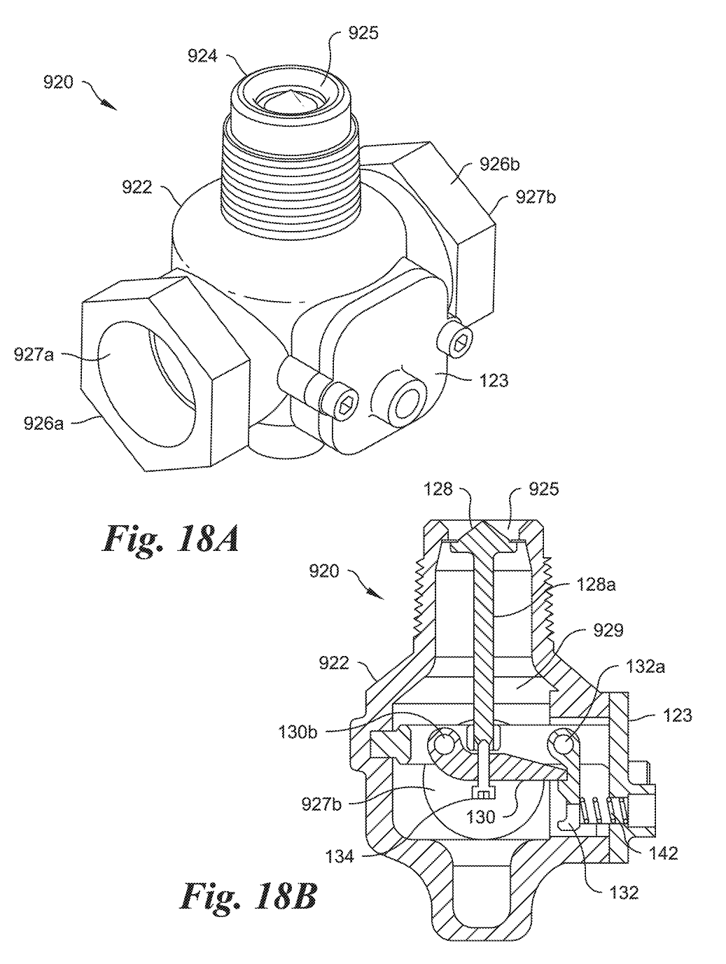

FIGS. 18A and 18B depict yet another embodiment of a valve component 920 having a second outlet on the valve body fluidly connected with the inlet through the passageway. It will be appreciated that the two outlet valve 920 of FIGS. 18A and 18B could be substituted for the single outlet valve 2140 and tee 2150 combination in any of the preceding examples. It will be further appreciated that other types of valves, including but limited to clapper-type valves can be used. In FIGS. 18A and 18B, a valve component 920 again includes a body 922 with an inlet end 924 and an inlet 925 externally threaded to be received in a Tee in a wet supply line (neither depicted) and, in this embodiment, first and second outlet ends 926a and 926b having first and second outlets 927a and 927b, respectively. The outlets 927a, 927b are fluidly connected with the inlet 925 by the passageway 929. Each outlet end 926a, 926b is not threaded in this embodiment to enable the valve component 920 to be used with plastic pipe drop tubes fabricated by the installer. However, each outlet end 926a, 926b could be internally threaded to receive an externally threaded length of metal drop tube, again fabricated on site by the installer. The valve component 920 may be connected to a system comprising first and second piping fluidly connecting the first and second water discharge devices with the first and second outlets 927a, 927b.

In the valve component 920, a cover 123 (as show in FIGS. 4-6) closes the opening through the sidewall of the body 922. The internal components of the valve member 920 are the same as those of valve member 1120, with the same seal member 128 supported by the same subassembly 148 (see FIGS. 3A, 3B), including a lever 130, and a latch 132 supported in the same way on the inside of the cover 123 with a bias member/compressed coil spring 142 mounted so as to bias the latch 132 into releasable engagement with the lever 130. The latch 132 pivots around a latch pivot 132a, which is a pinned connection. Similarly, the lever 130 pivots around a latch pivot 130b, which is also a pinned connection.

The latch 132 of the valve component 920 is again connected with an activation component (not depicted) like previously identified 60, 1160 or 960 via a flexible connector (not depicted) like previously identified 50. The principal difference between this valve component 920 and the valve component 1120 is the provision of two opposing outlets 927a, 927b oriented essentially perpendicularly to the inlet 925 and seal member 128 instead of having a single outlet in line with the inlet 125 and the seal member 128. The lever 130 includes the adjustment screw 134 located to contact a distal end of the shaft and 128a to vary mechanical compression applied to the seal member 128 by the lever 130 in the closed position.

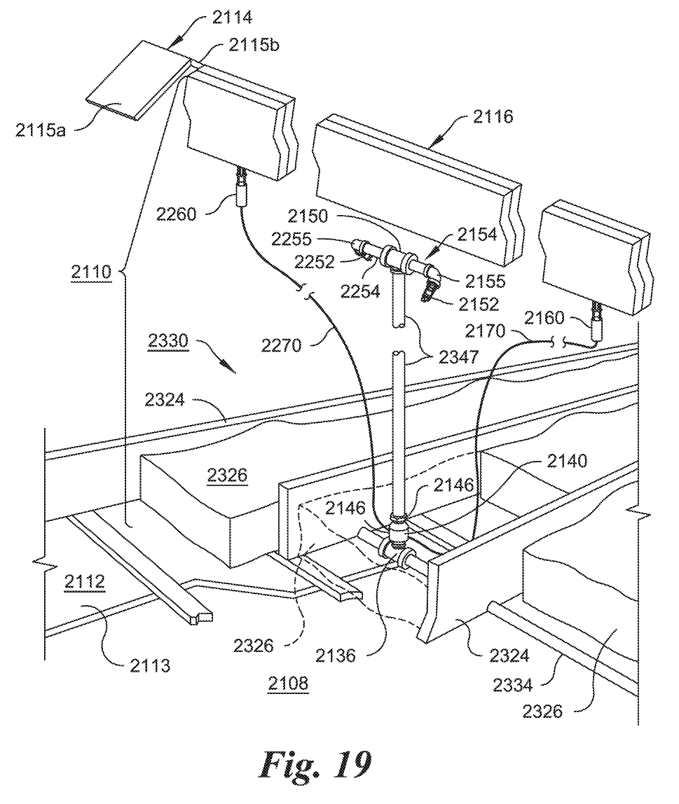

FIG. 19 depicts another possible system installation 2230 of the present invention. NFPA code permits the provision of water supply piping in unheated areas subject to freezing including unheated combustible concealed locations if the wet portion of the system are sufficiently insulated. So, for example, a water supply line may be installed above the ceiling of a heated lower space if covered with sufficient insulation to prevent freezing. In such an installation, the water supply line may run horizontally through the combustible concealed space along the floor with the valves located above the water supply line. The water supply line may run through wood members forming at least part of the floor. In such an installation, the water supply line and the valves are covered with non-combustible insulation sufficient to prevent freezing of the water supply line and the valves. For example, in FIG. 19, a branch supply line 2334 containing water is extended through wooden members forming the floor/deck 2112, like joists 2324 that support the ceiling 2113 over a heated space 2108 below the attic/combustible concealed space 2110 being fire protected by the system 2330. Branch supply line 2334 runs parallel to and beneath the peak 2116 of the pitched roof 2114. Tees 2136, etc. are again provided at spaced intervals along the branch line 2334, each with the transverse/outlet arm pointed upwardly and fluidly connected to the inlet of a preaction valve 2140 over the tee. The outlet 2146 of the valve 2140 is fluidly connected through an elongated delivery pipe 2347 extending from proximate the floor 2112 to the inlet of a second tee fitting 2150 located proximate to the peak 2116 of the pitched roof 2114. The tee 2150 supports piping 2154, 2254 in either direction parallel to the peak including elbows 2155, 2255 which, in turn support water discharge devices, e.g. open sidewall sprinklers 2152, 2252 directed laterally outwardly from the peak 2116 toward the opposing eaves. The piping 2347 between the outlet of the tee 2136 and the first and second water discharge devices 2152, 2252 preferably supports the first and second water discharge devices 2152, 2252 at least seven feet above the floor 2112.

Since the seal 28 (see FIGS. 4A-4B) at the inlet end of the valve 2140 is received in the tee 2136 and the rest of the assembly downstream from (i.e. physically above in FIG. 19) the closed seal 28 is dry, the system is not subject to freezing. Insulating the supply pipe 2234 including the tees 2136 in the permitted way with at least six inches of non-combustible insulation 2326 atop all wet components above the ceiling 2113 and with thicker insulation in colder climates prevents freezing of the supply line 2334 and the valve(s) 2140. Since the valve 2140 is located at the very bottom of the concealed space 2110, sufficiently long flexible connectors 2170, 2270 need to be provided with their thermal activation components 2160, 2260 to reach mounting locations proximate the roof peak 2116. Flexible connectors of the type previously described can be obtained in lengths of more than one hundred feet, if necessary.

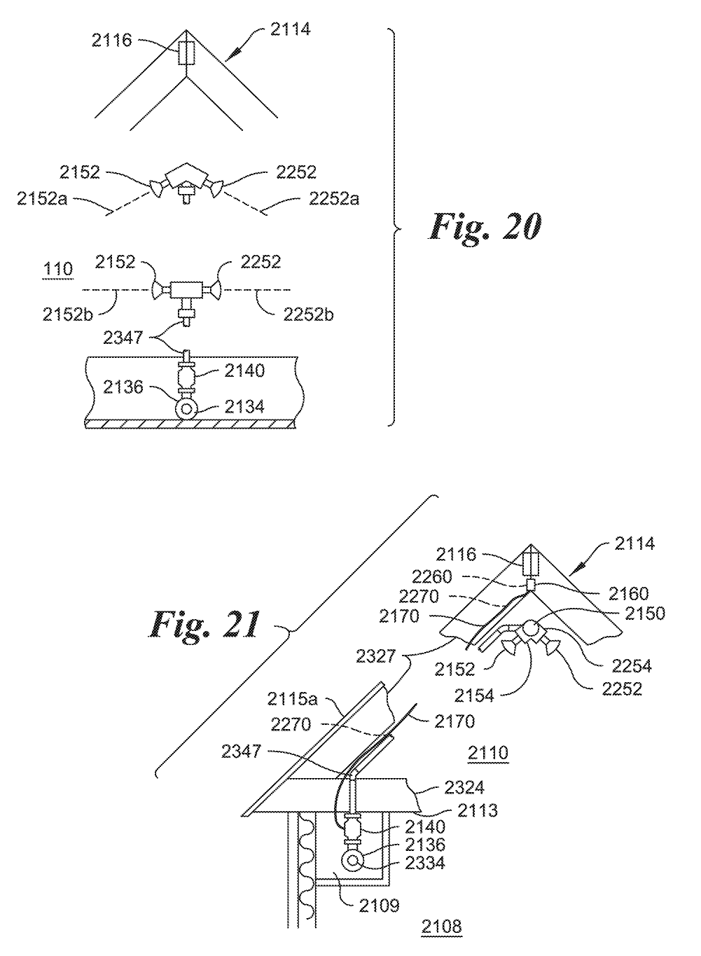

Although the pipe 2347 in FIG. 19 extends from the valve 2140 in or proximate to the floor 2112 to proximate to the peak 2116, it need not extend so high. Because the sprinklers 2152, 2252 do not have to be located at the peak 2116 to be activated, they can be supported well below the peak 2116. So, for example, a concealed space 2110 measuring 40 feet across the floor 2112 between the eaves 2118a, 2118b but with a 12/12 roof pitch providing a twenty foot height at peak 2116 (e.g., see FIG. 1), would not be protected by a pair of horizontal sidewall sprinklers 2152, 2252 having horizontal throws of only twenty-six feet positioned proximate to the peak as illustrated in FIG. 19, for example, since that provides a coverage area length of only eighteen and one-half feet from each sprinkler when the throw of the sprinkler is projected down and measured along the floor 2112. However, referring to FIG. 20, if the sprinklers 2152, 2252 are positioned at least four feet down from the peak 2116, (i.e. sixteen or less feet above the floor 2112), the sprinklers 2152, 2252 can be aimed at a 10/12 pitch or flatter, as indicated by broken lines 2152a, 2252a representing the centerlines of the outlet orifices of the sprinklers 2152, 2252, which does provide at least twenty feet coverage in either direction from the peak 2116 across the floor 2112. If usage of the concealed space 2110 allows, the side wall sprinklers 2152, 2252 could be installed well below the peak 2116 with the outlet orifice centerlines 2152b, 2252b horizontal or nearly so. Many if not most standard, light hazard, side wall sprinklers are designed to be located between seven and seven and one-half feet above the floor 2112 (the normal height when installed beneath flat eight foot ceilings) to be credited with the full length of throw along the floor 2112. Typically, at a height of between seven and seven and on-half feet (or more) above the floor 2112, depending, upon the sprinklers 2152, 2252, the sprinklers 2152, 2252 could be aimed horizontally to provide up to 50 feet of coverage between the eaves 2118a, 2118b. Any of the other previously described examples could be similarly lowered from the peak or extended only part way up from the floor toward the peak to extend the overall coverage areas of the sprinklers used.

Instead of running the single branch supply line down the middle of the space 2110 along the floor 2112 and above the ceiling as in FIGS. 19 and 20, a main supply line with preaction valves can be run in other locations sufficiently warm to prevent freezing and a dry pipe extended from each valve to a water discharge device or set of such devices above the floor 2112. In FIG. 21, water supply line 2334 is located in a heated soffit 2109 in the heated occupied space 2108 beneath a ceiling 2113 separating that space from the unheated combustible concealed space 2110 above it. Water supply line 2334 again includes a number of regularly spaced tees 2136, etc., with upwardly extended outlets, each supporting a separate valve 2140, etc. Piping 2347 from the outlet of each valve 2140 is run along the proximal pitch 2115a (or a rafter or truss 2327) of the sloped roof 2114 to a location proximate to the peak 2116 where the piping 2347, for example, supports a tee 2150 with piping 2154, 2254 and discharge devices 2152, 2252 under and proximate to the peak 2116. Flexible connectors/cables 2170, 2270 can also be extended up the pitch 2115a with the pipe 2347 and their connected thermal activation components 2160, 2260 (behind 2160 in the figure) installed in appropriate locations proximate the peak 2116. The described arrangement negates the need to pierce the joists, protects the flexible connectors/cables 2170, 2270 (behind 2170 in the figure) and keeps the combustible concealed area 2110 below the roof 2114 essentially completely open.

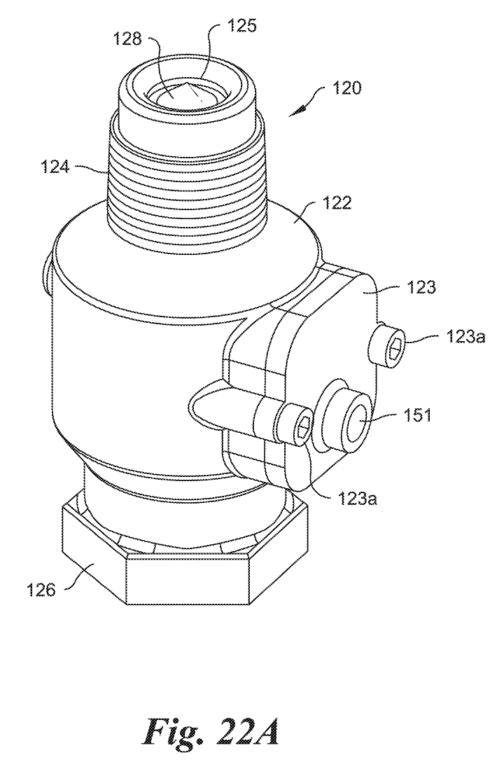

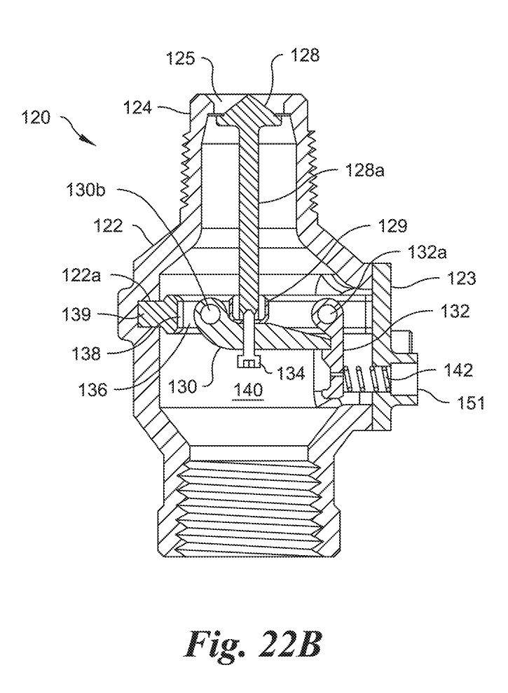

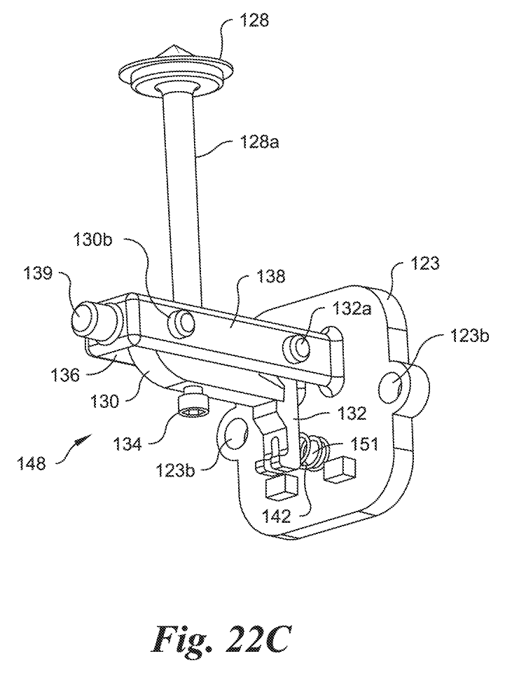

FIGS. 22A-22C depict a further embodiment of a valve component 120 of the invention in the form of a poppet valve. The valve component 120 includes a body 122 with an inlet end 124 externally threaded to be received in a Tee in or a threaded pipe from a wet supply line and an outlet end 126 internally threaded to receive an externally threaded length of piping. A seal member 128 is supported in the inlet 125 by a pivotally mounted lever 130 retained in a “closed” or “supporting” position by a pivotally mounted latch 132. An adjustment screw 134 can be provided in the lever 130 to vary the mechanical compression provided on the seal member 128. Two parallel cross-members 136, 138 span an enlarged central chamber 140 of the body 122 and terminate in a pin 139 received in a bore 122a in an inner side wall of the body 122 distal to a removable cover 123. The cross members 136, 138 support pivots for the lever 130 and the latch 132. A hollow boss 129 formed between the cross members 136, 138 slidably receives the shaft portion 128a of the seal member 128. A first bias member, for example, a compressed coil spring 142, biases the latch 132 into releasable engagement with the lever 130. The latch 132 is configured to be connected with an activation assembly and flexible connector as previously described. The latch 132 pivots around a latch pivot 132a, which is a pinned connection. Similarly, the lever 130 pivots around a lever pivot 130b, which is also a pinned connection The latch 132 is adapted to connect with a first end of a flexible cable of a flexible connector, while a port 151 is provided in the cover 123 for receiving a first end 152a of an outer cable housing 152 of the flexible connector. In FIG. 22C, a support subassembly 148 is shown removed from the valve body 122. The lever 130 and the latch 132 are part of the subassembly 148 pivotally supporting the lever 130 and the latch 132 and fixedly connected to a cover 123 removable from the valve body 122. The subassembly 148 includes the hollow boss 129 slidably receiving the shaft 128a of the seal member 128, The lever 130 includes the adjustment screw 134 located to contact a distal end of the shaft and 128a to vary mechanical compression applied to the seal member 128 by the lever 130 in the closed position, The cover 123 is secured by two screws 123a (FIG. 22A) through two screw holes 123b (FIG. 6).

It is expected that the valve component 120 will be rated for a maximum operating pressure of 250 psi, in which case the valve component 120 would be tested by a testing laboratory for many hours at that pressure or slightly higher without leakage for approval. It is suggested that for testing during, manufacture, the valve component 120 need only to sustain a pressure twice as great as the rated pressure without leakage for a short period of time (e.g. seconds). With an approximately three-quarter inch diameter inlet 125, a 250 lbs force Belleville washer in the seal member 128, and 500 psi water pressure (twice the expected rated maximum operating pressure) on the seal member, the total load on the lever 130 would be approximately 460 lbs. By proper dimensioning and locating of the lever 130 and the latch 132, in particular, locating the contact point between the lever 130 and the latch 132 along or at least near a transverse center line across the latch pivot 132a to eliminate or minimize any moment on the latch 132, a force of only 20 lbs from compression spring 142 can maintain the latch 132 engaged with the lever 130 and thus keep the valve component 120 closed. There is no tension on the flexible cable 54 when the valve 120 is closed; and, in a worst case, tripping the valve at 500 psi requires only about 100 lbs force for the cable 54 to pull. Thermally responsive elements such as 68 are rated to sustain force loads of up to 200 lbs, so that the provision of a 1000 lbs force spring for the bias member 66 is achievable.

Operation of the valve component 20 or 120 by means of the thermal activation assembly 10 is straight forward. The valve component 20, 120 is installed in the configuration of FIG. 4. When the thermally sensitive element 68 is heated to a predetermined thermodynamic condition to break, the movable member 64 in the thermal activation component 60 is released. The bias member 66 is selected to generate a force overcoming the bias of the bias member 42 and pivot the latch 32 or 132 out of engagement with the tang 30a of lever 30 or lever 132. The pressure of water at the inlet 25, 125 forces the seal member 28, 128 and the lever 30, 130 to back away from the inlet 25, 125 and into the central chamber 40, 140, permitting water to flow around past the lever 30, 130 and the latch 32, 132 and through the outlet 27, 127.

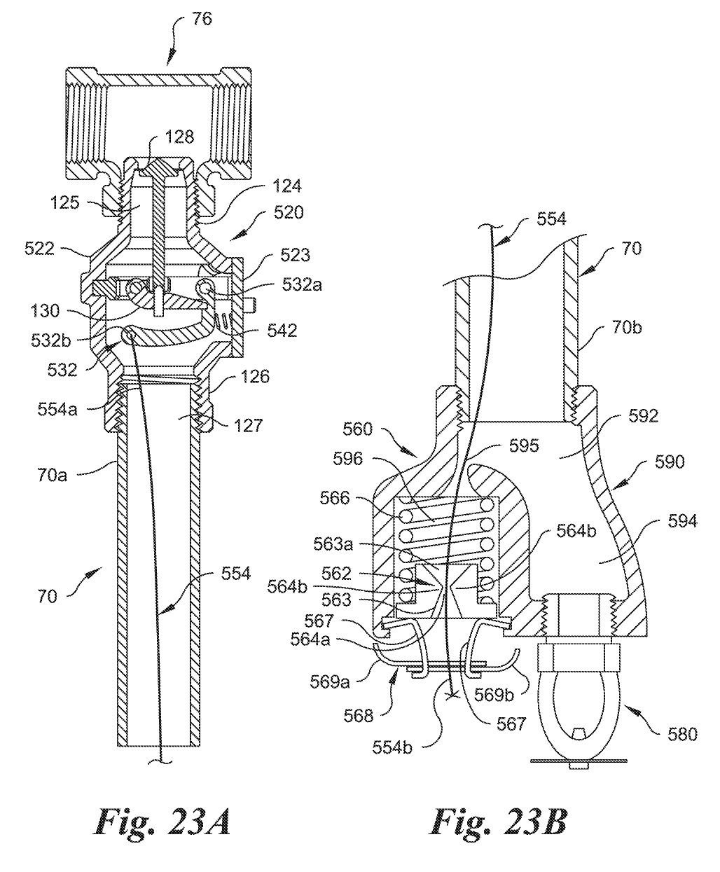

FIGS. 23A and 23B depict another embodiment of a valve component 520 connected with a sprinkler 580. The devices shown in FIGS. 23A and 23B may be used in a variety of sprinkler systems installed to protect combustible concealed spaces, including for example, a system installed to protect a combustible concealed space 2110 located in a structure between a floor 2112 protected by the system and a sloped roof 2114 over the floor 2112, as described in connection with FIG. 1, with the exception that the valve component 520 and the flexible connector is a single wire 554 are different in their details from the valve components and flexible connectors used in the system of FIG. 1. The valve component 520 includes a body 522 with an inlet end 124 having an inlet 125 externally threaded to be received in a Tee 76 in a wet supply line, and outlet end 126 having an outlet 127 and internally threaded to receive an externally threaded length of drop tube 70, fabricated on site by the installer. A modified cover 523 closes the opening through the sidewall of the body 522. The internal components of the valve member 520 are the same as valve member 120 with the exception of a modified latch member 532 and a bias member 542 mounted to the inside of the modified cover 523 so as to bias the a latch 532 into releasable engagement with the lever 130. The latch 532 is connected with an activation component 560 depicted in FIG. 23B via a flexible connector which, in this embodiment, is a single flexible wire 554. The latch 532 is pivotable and engaged with the lever 130 and has a latch pivot point 532a, the latch forming a moment arm configured to provide a torque to rotate the pivotable latch 532 about the latch pivot point 532a. The first end 554a of the flexible wire 554 is connected with the lever 532 at opening 532b. The remainder of the wire 554 is extended through the drop tube 70 to activation component 560.

Referring, to FIG. 23B, the activation component 560 is provided in a special fitting 590 for installation of a water distribution device 580, which might be a standard pendent sprinkler (sprinkler without a thermally responsive element and plug) as depicted, or a nozzle or other water distribution device. The fitting 590 has a fluid inlet 592 internally threaded to receive the discharge end of the drop tube 70 fabricated and installed in the field. The fitting 590 has an internally threaded fluid outlet port 594 receiving the a standard water distribution device 580 in the same way as a normal fitting connecting an externally threaded sprinkler inlet with an externally threaded discharge end of the drop tube 70. A separate chamber 596 of the fitting 590 forms a body housing the parts of activation component 560. The remaining end 554b of the flexible wire connector 554 extends into the inlet 592 and through a small opening or wire guide hole 595 into the separate chamber 596, the guide hole 595 being located along the edge of the flow path between the inlet 592 and outlet 594. A bias member 566 biases a wire securement member 562 outwardly with respect to the chamber 596—that is, away from the fluid inlet 592 of the fitting 590, The wire securement member 562 is restrained in the chamber 596 by a less common but conventional thermally responsive element 568. A pair of arms 567 restrain the securement member 562 to hold the bias member 566 in compression and are themselves held apart by the thermally responsive element 568, which is formed by a pair of overlapped plate pieces 569a, 569b held together by a solder connection therebetween. When the element 568 is heated sufficiently to soften the solder connection, the compressed spring 566 forces the arms 567 out of the chamber 596, causing the plate pieces 569a, 569b to separate and release the wire securement member 562. The wire securement member 562 has a body 563 with a conical “inlet” end 563a and a central bore 564a, through which the installer passes a second end 554b of the flexible connector wire 554. A plurality of teeth 564b are positioned within or around or otherwise define the bore 564a and are oriented so as to grip the second end 554b of the wire 554 passing from the inlet end 592 through the opening 595 and through the bore 564a to prevent retraction of the wire 554 back toward the inlet end 592 of the fitting 590. The first thermally responsive element 568 is thus operably connected to the wire securement member 562 such that when the first thermally responsive element 568 is exposed to an elevated temperature, the bias member 566 forces the wire securement member 562 away from the valve 520, causing the wire 554 to pull on the moment arm formed by the latch 532, allowing the seal member 128 to move from the fluid passageway 129 to permit fluid flow through the fluid passageway 129 of the valve 520. Alternatively, a plug member bearing the teeth 564b and a spring might be provided in a sprinkler head installed in a single outlet port of the fitting, whereby the flexible connector extends between the valve component and the sprinkler head/activation component entirely within the drop tube.

Although a rigid drop 70 is depicted, it will be appreciated that a flexible tube might be used between the valve 520 and the fitting 590 as this embodiment allows for a final adjustment of the length of the wire 554 after the valve 520 and fitting 590 are secured in their final location.

In use, the fire protection sprinkler system installer prepares the drop tube 70 and then passes a free end 554b of the wire 554 through an inlet end 70a of the drop tube 70. The free end 554b of wire 554 is then passed from the outlet end 70b of the tube 70 and through the inlet 592 of the fitting 590, through the small opening 595 into the chamber 596 and through the bore 564a of the wire securement element 562. The inlet end 70a of the drop tube 70 is secured with the outlet 127 of the valve body 522, preferably before the wire end 554b is secured in the fitting 590 but valve component and drop tube 70 may be secured together afterwards. The fitting 590 is attached to the outlet end 70b of the drop tube 70 so that the fitting 590, the drop tube 70 and the valve component 520 are fixedly connected together. The free end 554b of the wire 554 is pulled through the bore 564a until the wire is taut. The excess portion of the free end 554b of the wire is then cut off by the installer to complete the preacliun assembly. At any point in this process, the water distribution component 580 is installed in the fluid outlet 594 of the fitting 590 to complete the installation.

Preferably, the flexible connectors 50, 1150, 1250, 2120, 2220, 2170, 2270, 2170 , 2270 , 2170 , 2270 are Bowden cables. The outer cable housing 52, 1152, 1252 is typically formed by tightly spirally wound wire which prevents kinking and protects the flexible inner cable 54, 1154, 1254. Typically, an internal lubricant or coating is provided between the outer cable housing 52, etc., and the flexible inner cable 54, etc., which again prevents restriction between the outer housing 52, etc. and the flexible inner cable 54, etc. The cables can be manufactured to operate at −65° F., well below any temperature to which the thermal activation components would be exposed. Although a simple two-piece cable 50, etc. with inner cable 54, etc. and spiral wound outer housing 52, etc. is preferred, it will be appreciated that the flexible connector 50, etc. might be provided as a metal wire or cable in a polymer tube, such as bicycle cables are constructed, if the latter, it is suggested and preferred that the metal wire/plastic tube connector be provided in a protective coiled wire outer sleeve, again for protection.

It will be appreciated that by separating the closure provided by the valve component and the thermal activation provided by the thermal activation component of the preaction valve assembly from the water discharge devices, those water discharge devices no longer need to be upright because the water discharge devices do not need to be exposed rapidly to heat sufficient to activate as they would be if they were closed water discharge devices. Similarly, the water discharge devices need not be positioned close to the underside of a roof and/or the peak, again as would be needed by closed (i.e. automatic) sprinklers to activate timely. Furthermore, any open sprinklers used need not be subject to minimum spacing requirements to avoid cold solder because the water discharge devices need not be heated to activate. Through the provision of adequate piping, discharge devices can be located anywhere in the protected space where they would be deemed most effective, including spaced well down from the peak and piped around obstructions.

Existing back-to-back and single-direction, special-application attic sprinklers have special deflectors that need to be matched to the pitch of the roof of the attic or concealed space. Ordinary, existing open wet sprinkler heads are expected not to require special deflectors when used in a system according to the invention. Instead, the sprinklers can be simply mounted with the deflectors parallel to the pitch of the overlying roof portion or if mounted directly or sufficiently below the peak, with the deflectors horizontal.

The use of six-foot spacing between adjoining thermal activation components is based on response times of special-application attic sprinklers by the testing laboratories. Six foot maximum spacing between thermal activation devices is expected to remain the requirement of the testing laboratories for attic sprinkler systems until fire tests of the present invention successfully demonstrate a wider spacing. As shown, the use of two thermal activation components per valve permits coverage area lengths of at least 12 feet in the direction of the peak 2116/ridge line 2117, However, the provision of three thermal activation components would provide coverage area lengths of at least eighteen feet along the peak/ridge line with spacing of no more than six feet between thermal activation components. One thermal activation component would be located in the middle of the length and the other two would be located 6 feet to either side of the first. Each outer activation component would be spaced three feet from an adjoining wall or six feet from the nearest adjoining thermal activation component of the same or next adjoining preaction valve assembly and responsible for sensing along a length of three feet to either side of the component. This would permit the use of a much wider selection of existing wet sprinklers including pendent and upright ceiling as well as sidewall sprinklers having more squarish coverage areas, for example 18 by 22 feet, to stay within the current testing laboratory maximum coverage area requirement of 400 square feet for extended-coverage, light-hazard protection. Later it may be possible, with testing and approval, to use a single wet sprinkler in a system according to the invention to provide coverage for areas exceeding 400 square feet.

While open, existing wet system sprinklers have been shown to be convenient for designing attic protection systems because their distribution characteristics are well known and are easily commercially obtained, generally at a very small fraction of the cost of special application attic sprinklers, the fire protection systems of the present invention are not limited to existing sprinklers. Furthermore, they are not limited to spray-type sprinklers as directional spray nozzles can also be used as discharge devices. The use of preaction valves creates the possibility to design still other types of discharge devices with other distribution patterns and coverage areas different from those of existing sprinklers and nozzles, for example, narrower and longer throws such as 12 feet wide by 33 feet long, or 10 by 40 feet, 8 by 50 feet, 6 by 66 feet or even 4 by 100 feet and still stay within the 400 square foot coverage area limit for light hazard sprinklers.

While the thermal activation components of the example systems disclosed above have been suggested to be located at the peak of pitched roofs, their flexible connections allow them to be located anywhere in the protected space they are found to be effective. Flexible connectors of the type identified can be provided in relatively great lengths (one hundred feet or more) if necessary or desired. Thus, with the present invention, it would be possible to install a fire protection system in an attic with a pitched roof at a height of only 7 or 8 feet above the floor to duplicate a flat ceiling installation. Flexible connectors could be run from that height to the peak, even in the widest spans (eave to eave) and at the greatest pitch (12/12) encountered.

The use of preaction valves also opens the possibility of locating discharge devices and/or designing other discharge devices and other systems that can effectively provide extended coverage, light hazard fire protection with water delivered at densities of less than 0.1 gallon per minute per square foot of coverage area.

In another aspect, the present invention is a method of installing a fire protection system 2130 in a combustible concealed space 2110 within a structure between a sloped roof 2114 and a floor 2112 beneath the roof 2114 of the structure. The following description uses element numerals with respect to one embodiment described herein, but is equally applicable to the remaining embodiments. The layout of the system 2130 as shown in FIGS. 1 and 7-8, while the internal details of the valve 2140, 2140 and the thermal activation component 2160, 2260, 2160 , 2260 are described with respect to the embodiment of FIGS. 4A and 4B. The method includes providing a water supply line 2134 to the system 2130. The method also includes fluidly connecting an inlet 25 of a first valve with the water supply line 2134. The first valve 20 includes a first outlet 27, a passageway fluidly connecting the inlet 25 with the first outlet 25, and a seal member 28 along the passageway/central chamber 40. The seal member 28 is supported in the valve 20 so as to move between a closed position and an open position to respectively block and open the passageway (central chamber 40) to fluid flow between the inlet 25 and the first outlet 27. The method also includes installing a first water discharge device 2152 at a location remote from the first valve 2140 and orienting the water discharge device 2152 to spray water delivered to the water discharge device 2152 onto at least a first portion of the floor 2112; this step may include installing and orienting one of an open pendent, sidewall or upright sprinkler or a nozzle over the floor. The method also includes fluidly connecting at least the first water discharge device 2152 with the first outlet 27 to receive water from the first valve 2140. The method also includes installing a first thermal activation component 2160 in the combustible concealed space at a location remote from the first valve 2140 and the first water discharge device 2152. The first thermal activation component 2160 includes a first thermally responsive element 68 (FIG. 4A) selected to undergo a physical change when heated to at least a predetermined temperature. The method further includes mechanically operably connecting the first thermal activation component 2160 to the first valve with a first flexible connector 2170. The first flexible connector 2170 is connected with the valve 2140 so as to initiate movement of the seal member 28 from the closed to the open position in response to the physical change of the first thermally responsive element 68 in the first thermal activation 2160 assembly due to heating of the first thermally responsive element 2160. The first flexible connector 2170 is preferably operably connected to the first valve 2140 and the first thermally responsive element 68 so as to open the first valve 2140 in response to a loss of physical integrity of the first thermally responsive element 68. The first flexible connector 2170 may preferably comprise a Bowden cable.

A method according to the present invention may further include installing a second thermal activation component 2260 in the combustible concealed space 2110 at a location proximate to the peak 2116 of the roof 2114 and remote from the first valve 2140, the first water discharge device 2152, and the first thermal activation component 2160, the second thermal activation component 2260 including a second thermally responsive element 68 (see FIG. 4A) also selected to undergo a physical change when heated to a predetermined temperature. The method may further include mechanically operably connecting the second thermal activation component 2160 to the first valve 2140 with a second flexible connector 2270, the second flexible connector 2270 initiating movement of the seal member 28 from the closed to the open position in response to physical change of the second thermally responsive element 68 in the second thermal activation component 2260 independent of any operation of the first flexible member 2170 and first thermally responsive element 68.

All known dry sprinklers have to be sized for a particular installation to within a fraction of an inch in length. All known dry sprinklers are not designed for length adjustment of any kind in the field or, at most, are designed for only the most minimal length adjustment in the field. Consequently, all have to be made to some measured length at a factory and not in the field by the installer. In addition to the time mentioned earlier to custom fabricate each sprinkler at the factory and the potential problem of measurement or fabrication length errors, the custom sprinklers have to be shipped to the installer and may be damaged in transit.

The maximum length/height of commercially available dry sprinkler heads is four feet, which establishes the maximum distance from a wet, water supply line. Thermal activation. assemblies of the present invention can be supplied with flexible connectors having a single given maximum length greater than or equal to four feet or in different lengths, for example in integer or two or three foot increments. Any of these options would represent significant savings and installation versatility compared to custom length, dry sprinklers.

Standard automatic sprinkler heads that is, sprinkler heads that are testing laboratory approved and listed for NFPA 13—can be installed with the subject thermal activation assemblies and preaction valves of the invention, in the field, at the same time the rest of the fire sprinkler system is being installed. The installer simply cuts or assembles a length of pipe (i.e. the drop) on the job as he would with a standard wet sprinkler system and attaches a standard open or automatic sprinkler head to the drop. The installer can finish the system installation with no delay or special procedures. Fire protection is immediately available while the rest of the construction is finished, whereas with dry sprinkler systems there would be no protection until after the specially ordered, dry sprinklers were installed, days and even weeks after the supply piping is installed.

Being able to install any standard automatic sprinkler head into a dry sprinkler device is itself a significant advantage. In addition to specific lengths, installers of dry sprinkler systems have to specify other characteristics to order dry sprinklers, including orientation (sidewall, upright or pendent and, if pendent, exposed, recessed or hidden), operating temperature, orifice size, finish and/or color. There are literally many hundreds if riot thousands of different automatic sprinkler heads available from a variety of manufacturers that can be used, off the shelf, with valve components of the present invention to satisfy the thousands of potential combinations of these characteristics. Since only the valve components of the dry sprinkler devices of the present invention need approval from the recognized testing laboratories, it will be possible to install virtually any automatic sprinkler head (open or plugged) with a valve component of the present invention, without limitation, to provide a dry system.

While there are literally many hundreds if not thousands of possible different characteristic combinations for fire sprinklers, and many manufacturers willing to commercially supply those combinations in automatic sprinkler heads, the manufacturers only supply no more than about one-tenth of those characteristic combinations in dry sprinklers because each dry sprinkler must be tested independently by the approving labs as to operation, corrosion, and other performance characteristics. With each dry sprinkler costing more than $10,000 to be tested for approval by one of the recognized testing laboratories, manufacturers limit the varieties of dry sprinklers available because the market is not so big as to justify those approval expenses for the full range of available wet system sprinkler heads. Once approved, the preaction valve with thermal activation assemblies of the present invention will instantly allow virtually every laboratory approved standard automatic sprinkler head of every manufacture to be installed as a dry sprinkler device. This will give sprinkler system designers, building owners, and installers a virtually unlimited choice of sprinkler heads to use to save installation costs.

Since the valve components of the present invention can be mechanically tripped, they can be further be configured or accessorized to be separately remotely tripped, automatically or on demand.

Thermal activation assemblies of the present invention can be configured to automatically trip at a temperature below, above, or equal to the rated temperature of the connected automatic (i.e. plugged) sprinkler head(s) by selection of the operating temperature of the thermally responsive element of the activation component to be lower or higher compared to that of a corresponding plugged sprinkler head. Thus, it is possible to preload the sprinkler head with water prior to activation, if desired, or delay loading of the sprinkler head until after the sprinkler head has opened.

When used to provide a two-step activation, thermal activation assemblies of the present invention also give superior protection against vandalism or accidental damage, false trips or faulty sprinklers, and water damage a major concern of both insurance companies and building owners. If a sprinkler is damaged prior to normal activation—for example, a bulb or other thermally responsive element breaks or is accidentally broken, or is defective (i.e. permits leak)—no water is released since the “independent” activation component of the present invention would not be triggered by damage to the sprinkler. Not only does this arrangement prevent water damage from unintended activation, the arrangement allows immediate field repair without removing the system from protective service and without having to wait for a factory manufactured replacement assembly. The system can be fully repaired, in the field, like a standard wet system. (Maintaining an active system during head repairs has been notoriously very expensive, with sophisticated equipment required.)

If the thermal activation component of a system with automatic (i.e. plugged) sprinkler heads is configured to open the valve component before sprinkler activation, fire protection is improved because there is no air to escape before the water flows from the sprinkler heads. The valve component prefills the sprinkler heads before conditions reach the activation temperature of the sprinkler heads.

A preaction valve with a thermal activation component of the present invention potentially allows plastic piping to be used as drops in areas that would have normally required dry sprinklers, provided that the valve component can be located in an area protected from and/or otherwise not subjected to freezing temperatures. This represents a tremendous savings in installation time and costs, particularly in those residential and light hazard systems otherwise amenable to plastic pipe installation throughout. The assemblies can be configured by selection of the thermally responsive elements 68, etc. to operate at a temperature above that at which the thermally responsive elements used in any automatic (i.e. plugged) sprinklers activate to assure there is no water inside the drop or pressurization of the drop until the thermally responsive element of both the activation component and the sprinkler have reached their respective activation temperatures.

If the thermal activation component trips from breakage of the responsive element 68 or the equivalent, but the automatic (i.e. plugged) sprinkler does not activate, the exposed portion of the activation component provides a visual indication below the ceiling that the activation component has tripped and that water is in a potentially freezing area. If the sprinkler leaks, dripping of water provides a secondary indication of caution that the drop pipe is full of water and should be serviced.

In addition to providing a very economical alternative to compressed gas and antifreeze “dry” sprinklers, thermal activation assemblies of the present invention can further present the possibility of economical dry residential sprinkler systems, with two-stage operation providing added security from damage for the property owner.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. A sprinkler system installed to protect a combustible concealed space located in a structure between a floor protected by the system and a sloped roof over the floor, the system comprising:
a water supply line;
a first valve having a body with an inlet fluidly connected with the water supply line, a first outlet and a passageway fluidly connecting the inlet with at least the first outlet, the valve further including a seal member located in the body along the passageway, the seal member being supported in the body so as to move from a closed position to an open position to respectively block and open the passageway to fluid flow between the inlet and the first outlet;
a first water discharge device installed in the concealed space at a location remote from the first valve, the first water discharge device being oriented to spray water delivered to the first water discharge device onto at least a first portion of the floor;
first piping fluidly connecting the first water discharge device with the first outlet;
a first thermal activation component including a first thermally responsive element installed at a location in the concealed space remote from the first valve and the first water discharge device; and
first flexible connector mechanically operably connecting the first thermal activation component and the first valve, the first flexible connector initiating movement of the seal member from the closed to the open position in response to a physical change in the first thermally responsive element due to heating of the first thermally responsive element.

2. The sprinkler system of claim 1 wherein the first water discharge device is one of an open pendent, upright, sidewall, conventional, or single direction sprinkler and a nozzle.

3. The sprinkler system of claim 2 further comprising a second water discharge device installed in the concealed space distanced from the first valve and fluidly coupled with the first water discharge device and the first outlet by second piping.

4. The sprinkler system of claim 1 wherein the first flexible connector includes a first flexible inner member and a first flexible outer tube receiving the first flexible inner member sufficiently closely to permit sliding movement of the first flexible member within the first flexible outer tube with only a negligible amount of lost movement of the first flexible member between opposing ends of the first outer tube.

5. The sprinkler system of claim 1 further comprising:
a second thermal activation component including a second thermally responsive element, the second assembly being installed at a location spaced apart from the first valve, the first water discharge device and the first thermal activation component; and
a second flexible connector mechanically operably connecting the second thermal activation component and the first valve, the second connector initiating movement of the seal member from the closed to the open position in response to physical change of the second thermally responsive element due to heating of the second element.

6. The sprinkler system of claim 5 wherein the first and second thermal activation assemblies are spaced apart from one another and from the valve.

7. The sprinkler system of claim 5 further comprising a second water discharge device installed at a location spaced apart from the first valve, the first water discharge device, and the first and second thermal activation assemblies, the second water discharge device being oriented to spray water delivered to the second water discharge device onto a second portion of the floor; and
second piping fluidly connecting the second water discharge device with the first outlet of the first valve.

8. The sprinkler system of claim 7 wherein the first piping comprises one of a tee fitting and a cross fitting fluidly connecting the first water discharge device and the second piping with the first outlet of the first valve.

9. The sprinkler system of claim 5 further comprising a second outlet on the valve body fluidly connected with the inlet through the passageway.

10. The sprinkler system of claim 9 further comprising a second water discharge device installed at a location spaced apart from the first valve, the first water discharge device and the first and second thermal activation assemblies, the second water discharge device being configured to spray water delivered to the second water discharge device onto a second portion of the floor; and
second piping fluidly connecting the second water discharge device with the second outlet.

11. The sprinkler system of claim 1 wherein the water supply line runs horizontally through the combustible concealed space along the floor with the first valve located above the water supply line.

12. The sprinkler system of claim 11 wherein the water supply line runs through wood members forming at least part of the floor.

13. The sprinkler system of claim 12 wherein the water supply line and the first valve are covered with non-combustible insulation sufficient to prevent freezing of the water supply line and the first valve.

14. The sprinkler system of claim 12 wherein the first piping between the first outlet and the first water discharge device supports the first water discharge device above the floor.

15. The sprinkler system of claim 1 wherein the water supply line runs horizontally through the combustible concealed space and is filled with a pressurized gas.

16. The sprinkler system of claim 1 wherein the first valve is supported on the water supply line at a height above the floor completely below a height of the first thermal activation component above the floor and wherein the first water discharge device is supported by the first piping at a height above the floor completely below the height of the first valve.

17. The sprinkler system of claim 1 wherein the first thermal activation component comprises:
a base, a movable member movable with respect to the base, a bias member located with respect to the base to bias the movable member from a preactivation position with respect to the base to an activated position with respect to the base, and the thermally responsive element retaining the movable member in the preactivation position only until a predetermined thermodynamic condition is reached, the thermally responsive element being configured to lose structural integrity when exposed to the predetermined thermodynamic condition; and
wherein the first flexible connector comprises a flexible hollow outer cable housing with a first end connected with the first valve and a second end, configured to be stationarily connected with the base and a flexible cable slidably located inside the flexible hollow outer cable housing for sliding movement within the outer cable housing and having a first end and a second end connected with the movable member so as to be moved with respect to the flexible hollow outer cable housing by movement of the movable member with loss of structural integrity by the thermally responsive element at the predetermined thermodynamic condition.

18. The sprinkler system of claim 17 wherein the first end of the flexible hollow outer cable housing is configured for fixed connection with the body of the first valve and the first end of the flexible cable is configured for mechanical connection with a movable part of the first valve.

19. The sprinkler system of claim 17 wherein the thermally responsive element is one of an alcohol filled glass bulb and a fusible link.

20. The sprinkler system of claim 17 further comprising a switch mounted on the activation component so as to change states with movement of the movable member.

21. The sprinkler system of claim 18 wherein the second end of the flexible hollow outer cable housing is fixed with the base.

22. The combination of claim 17 wherein the first valve is either a poppet valve or a clapper valve.

23. The combination of claim 17 wherein the first valve has a pivotable lever and a seal member supportable across the passageway by the lever to close the passageway, the seal member being supported across the passageway in a sealing position by a latch engaged with the lever, the flexible cable having a first end mechanically coupled with the latch for movement of the latch with respect to the lever by movement of the first end of the flexible cable.

24. The combination of claim 23 wherein the first valve has a second outlet fluidly connected with the inlet by the passageway.

25. The combination of claim 23 further comprising a mechanism between the first end of the flexible cable and the latch mechanically coupling the first end of the flexible cable with the latch.

26. The combination of claim 25 wherein the mechanism includes a plunger.

27. The combination of claim 23 further comprising at least one of a fire sprinkler and a second valve fluidly coupled with the outlet of the first valve.

28. The sprinkler system of claim 1 wherein the first valve has a pivotable lever and a seal member supportable across the passageway by the lever to close the passageway, the seal member being supported across the passageway in a sealing position by a latch releasably engaged with the lever; and
the first thermal activation component comprises a base, a movable member movable with respect to the base, a bias member located with respect to the base to bias the movable member from a preactivation position with respect to the base to an activated position with respect to the base, and the thermally responsive element retaining the movable member in the preactivation position only until a predetermined thermodynamic condition is reached, the thermally responsive element being configured to lose structural integrity at the predetermined thermodynamic condition;
wherein the first flexible connector comprises a flexible hollow outer cable housing having first end configured to be stationarily connected with the body of the first valve and a second end configured to be stationarily connected with the base, and a flexible cable located inside the flexible hollow outer cable housing and sized for only sliding movement within the outer cable housing, the flexible cable having a first end mechanically connected with the latch and a second end engaged with the movable member to move with the movable member; and
the first water discharge device is fluidly coupled with the first outlet.

29. The sprinkler system of claim 28 wherein the first water discharge device is either an automatic fire sprinkler with a thermally responsive element and a plug or an open fire sprinkler lacking a thermally responsive element and a plug.

30. The sprinkler system of claim 28 further comprising:
a second water discharge device; and
piping fluidly connecting the first and second water discharge devices with the first outlet.

31. The sprinkler system of claim 28 further comprising:
a second thermal activation component including a base, a movable member movable with respect to the base, a bias member located with respect to the base to bias the movable member from a preactivation position with respect to the base to an activated position with respect to the base, and a thermally responsive element retaining the movable member in the preactivation position only until a predetermined thermodynamic condition is reached, the thermally responsive element being configured to lose structural integrity under the predetermined thermodynamic condition;
a second flexible connector including at least a flexible hollow outer cable housing having a first end configured to be stationarily connected with the body and a second end configured to be stationarily connected with the base, and a flexible cable located inside the flexible hollow outer cable housing and sized for only sliding movement within the outer cable housing, the flexible cable having a first end and a second end fixedly connected with the movable member of the second activation component so as to be moved with respect to the flexible hollow outer cable housing by movement of the movable member with loss of structural integrity by the thermally responsive element of the second thermal activation component under the predetermined thermodynamic condition, the first end of the flexible cable being mechanically connected with the latch and a crank.

32. The sprinkler system of claim 28 further comprising:
a second valve fluidly coupled with at least one outlet of the first valve.

33. The sprinkler system of claim 23 wherein the body of the first valve further comprises a cover removably attached to the body, and the lever and the latch are part of a subassembly pivotally supporting the lever and the latch and fixedly connected to the cover.

34. The dry sprinkler device of claim 33 wherein the subassembly further includes a hollow boss slidably receiving a shaft of the seal member and the lever includes an adjustment screw located to contact a distal end of the shaft and vary mechanical compression applied to the seal member by the lever in the closed position.

35. A method of installing a fire protection system in a combustible concealed space within a structure between a sloped roof and a floor beneath the roof of the structure, the method comprising the steps of:
providing a water supply line to the system;
fluidly connecting an inlet of a first valve with the water supply line, the first valve including a first outlet, a passageway fluidly connecting the inlet with the first outlet, and a seal member along the passageway, the seal member being supported in the valve so as to move between a closed position and an open position to respectively block and open the passageway to fluid flow between the inlet and the first outlet;
installing a first water discharge device at a location remote from the first valve and orienting the first water discharge device to spray water delivered to the first water discharge device onto at least a first portion of the floor;
fluidly connecting at least the first water discharge device with the first outlet receive water from the first valve;
installing a first thermal activation component in the combustible concealed space at a location remote from the first valve and the first water discharge device, the first thermal activation component including, a first thermally responsive element selected to undergo a physical change when heated to at least a predetermined temperature; and
mechanically operably connecting the first thermal activation component to the first valve with a first flexible connector, the first flexible connector being connected with the first valve so as to initiate movement of the seal member from the closed to the open position in response to physical change of the first thermally responsive element in the first thermal activation component due to heating of the first thermally responsive element.

36. The method of claim 35 further comprising the steps of:
installing a second thermal activation component in the combustible concealed space at a location proximal the peak of the roof and remote from the first valve, the first water discharge device and the first thermal activation component, the second thermal activation component including a second thermally responsive element also selected to undergo a physical change when heated to a predetermined temperature; and
mechanically operably connecting the second thermal activation component to the first valve with a second flexible connector, the second flexible connector initiating movement of the seal member from the closed to the open position in response to physical change of the second thermally responsive element in the second thermal activation component independent of any operation of the first flexible member and first thermally responsive element.

37. The method of claim 35 wherein the step of installing a first water discharge device comprises installing and orienting one of an open pendent, sidewall, or upright sprinkler or a nozzle over the floor.

38. The method of claim 35 wherein the first flexible connector is operably connected to the first valve and the first thermally responsive element so as to open the first valve in response to a loss of physical integrity of the first thermally responsive element.

39. The method of claim 35 wherein the first flexible connector comprises a Bowden cable.

40. A sprinkler system installed to protect a combustible concealed space located in a structure between a floor protected by the system and a sloped roof over the floor, the system comprising:
a water supply line;
a first valve having a body with an inlet fluidly connected with the water supply line, a first outlet, and a passageway fluidly connecting the inlet with at least the first outlet, the first valve further including a seal member located in the body along the passageway, the seal member being supported in the body so as to move from a closed position to an open position to respectively block and open the passageway to fluid flow between the inlet and the first outlet, the first valve further including a pivotable lever supporting the seal member across the passageway in a sealing position and secured in a sealing position by a pivotable latch engaged with the lever and having a latch pivot point, the latch forming a moment arm configured to provide a torque to rotate the pivotable latch about the latch pivot point;
a first water discharge device installed in the concealed space at a location remote from the first valve, the first water discharge device being oriented to spray water delivered to the first water discharge device onto at least a first portion of the floor;
first piping fluidly connecting the first water discharge device with the first outlet;
a first thermal activation component comprising a first thermally responsive element; and
a first flexible connector operably connecting the first thermal activation component and the first valve, the first flexible connector initiating movement of the seal member from the closed to the open position in response to a physical change in the first thermally responsive element due to heating of the first thermally responsive element,
the first flexible connector comprising a flexible wire having a first end and a second end and passing through at least a portion of the first piping, the first end operably connected to the moment arm and the second end operably connected to the first thermally responsive element.

41. The sprinkler system of claim 40 further comprising a fitting having a fluid inlet connected to the first piping, a fluid outlet connectable to the first water discharge device, a flow path leading from the fluid inlet to the fluid outlet, a separate chamber for housing the parts of the thermal activation component, and an opening connecting the passageway with the separate chamber.

42. The sprinkler system of claim 41 further wherein the second end of the flexible wire extends into the fluid inlet of the fitting and through the opening into the separate chamber, the opening being located along the edge of the flow path between the inlet of the fitting and the outlet of the fitting.

43. The sprinkler system of claim 42 further comprising:
a wire securement member disposed in the separate chamber and having a body with a conical inlet end and a central bore with a plurality of teeth disposed around the central bore and oriented to grip the second end of the flexible wire to prevent the flexible wire from moving toward the inlet end of the fitting,
a bias member operably attached to the flexible wire to bias the flexible wire away from the fluid inlet of the fitting;
a thermally responsive element operably connected to the second end of the flexible wire such that exposure of the thermally responsive element to heat permits movement of the second end of the flexible wire away from the inlet of the fitting;
a pair of arms restraining the securement member to hold the bias member in compression, the arms being held in spaced relation by the first thermally responsive element such that when the first thermally responsive element is exposed to an elevated temperature, the bias member threes the arms out of the separate chamber, allowing the wire securement member to move away from the fluid inlet of the fitting, causing the flexible wire to pull on the moment arm of the latch, allowing the seal member to move from the fluid passageway of the first valve to permit fluid flow through the fluid passageway of the first valve.

44. The sprinkler system of claim 40, wherein the first water discharge device is a sprinkler head, the system further comprising:
a wire securement member disposed in the sprinkler head and having a bore with a plurality of teeth disposed around the bore and oriented to grip the second end of the flexible wire to prevent the flexible wire from moving toward the first valve;
a bias member operably attached to the flexible wire to bias the flexible wire away from the fluid inlet of the fitting;
the first thermally responsive element being operably connected to the wire securement member such that when the first thermally responsive element is exposed to an elevated temperature, the bias member forces the wire securement member away from the first valve, causing the flexible wire to pull on the moment arm of the latch, allowing the seal member to move from the fluid passageway to permit fluid flow through the fluid passageway of the first valve.
